(19) United States
(12) Patent Application Publication
(10) Pub. No.: US 2026/0275652 A1
(43) Pub. Date: Sep. 17, 2026

(54) METHOD FOR DRY-FORMING CELLULOSE PRODUCTS FROM CELLULOSE FIBRES IN A PRODUCT FORMING UNIT AND A PRODUCT FORMING UNIT

(71) Applicant: PULPAC AB, Västra Frölunda (SE)

(72) Inventors: Olle HÖGBLOM, Göteborg (SE); Ove LARSSON, Västra Frölunda (SE)

(21) Appl. No.: 19/168,648

(22) PCT Filed: Mar. 11, 2024
(86) PCT No.: PCT/EP2024/056339

§ 371 Date: Sep. 24, 2025

(30) Foreign Application Priority Data
Mar. 28, 2023 (SE) 2350354-3

(51) Int. Cl. D21J 3/10

(52) U.S. Cl. CPC D21J 3/10

(57) ABSTRACT

A method for dry-forming a three-dimensional cellulose product from cellulose fibres in a product forming unit that includes a fibre transporting unit, a shaping unit including one or more shaping elements having a three-dimensional surface, and a forming mould M. The one or more shaping elements are arranged on a movable support structure. The method includes the steps: providing loose and separated cellulose fibres and feeding the loose and separated cellulose fibres to the one or more shaping elements by means of flow of air, and arranging the loose and separated cellulose fibres onto the one or more shaping elements, wherein the three-dimensional surfaces of the one or more shaping elements have a shape corresponding to or similar to a final shape of the cellulose product formed in the forming mould; dry-forming the cellulose product into a three-dimensional compressed fibre structure in a pressing operation by pressing and heating.

### TECHNICAL FIELD

The present disclosure relates to a method for dry-forming cellulose products from cellulose fibres in a product forming unit. The disclosure further relates to a product forming unit for dry-forming cellulose products from cellulose fibres.

### BACKGROUND

Cellulose fibres are commonly used as raw material for producing or manufacturing cellulose products. Products formed of cellulose fibres can be used in many different situations where there is a need for sustainable products. A wide range of products can be produced from cellulose fibres and one specific product category relates to cellulose products having a closed bottom portion, such as for example bottles, cups, and containers with a bottom portion.

Product forming units are used when manufacturing cellulose products from raw materials including cellulose fibres, and traditionally cellulose products have been produced by wet-forming methods. One material commonly used for wet-forming cellulose fibre products is wet moulded pulp. Wet-formed products are generally formed by immersing a suction forming mould into a liquid or semi liquid pulp suspension or slurry comprising cellulose fibres, and when suction is applied, a body of pulp is formed with the shape of the desired product by fibre deposition onto the forming mould. With all wet-forming methods, there is a need for drying of the wet moulded product, where the drying process is a time and energy consuming part of the production. The demands on aesthetical, chemical and mechanical properties of cellulose products are increasing, and due to the properties of wet-formed cellulose products, the mechanical strength, flexibility, freedom in material thickness, and chemical properties are limited. It is also difficult in wet-forming processes to control the mechanical properties of the products with high precision.

One development in the field of producing cellulose products, is dry-forming of cellulose products without using wet-forming methods. Instead of forming the cellulose products from a liquid or semi liquid pulp suspension or slurry, a cellulose structure air-formed from cellulose fibres is used. The cellulose structure is inserted into a forming mould and during the dry-forming of the cellulose products, the cellulose fibres are subjected to a high forming pressure and a high forming temperature. One difficulty with dry-forming methods is the problem with an efficient production process, where deep drawn cellulose products can be produced at high speeds with high quality. The air-forming and handling of the cellulose structure is a complicated and time consuming process when dry-forming the cellulose products, and there is a need for producing products with high finish at increased production rates. Thus, a more efficient product forming unit and method for producing high-quality cellulose products are desired, especially when forming deep drawn products.

### SUMMARY

An object of the present disclosure is to provide a method for dry-forming cellulose products from cellulose fibres in a product forming unit and a product forming unit for dry-forming cellulose products from cellulose fibres, where the previously mentioned problems are avoided. This object is at least partly achieved by the features of the independent claims. The dependent claims contain further developments of the method for dry-forming cellulose products and the product forming unit for dry-forming cellulose products.

The disclosure concerns a method for dry-forming a three-dimensional cellulose product from cellulose fibres in a product forming unit. The product forming unit comprises a fibre transporting unit, a shaping unit, and a forming mould. The shaping unit comprises one or more shaping elements having a three-dimensional surface. The shape of the shaping element corresponds to the shape of the forming mould and thus to the final shape of the cellulose product formed in the forming mould. The one or more shaping elements are arranged on a movable support structure. The method comprises the steps: providing loose and separated cellulose fibres to the fibre transporting unit, and feeding the loose and separated cellulose fibres in the fibre transporting unit by means of a flow of air to a fibre outlet of the fibre transporting unit; displacing the one or more shaping elements to the fibre outlet by movement of the support structure upon feeding of the loose and separated cellulose fibres from the fibre outlet to the one or more shaping elements by means of the flow of air as carrying medium for the cellulose fibres, and arranging the loose and separated cellulose fibres onto the three-dimensional surfaces of the one or more shaping elements by means of the flow of air for air-forming at least one three-dimensional body of cellulose fibres, wherein the three-dimensional surfaces of the one or more shaping elements have a shape corresponding to a shape of a three-dimensional pressing surface of the forming mould; displacing the one or more shaping elements with the at least one air-formed three-dimensional body of cellulose fibres away from the fibre outlet by movement of the support structure; dry-forming the cellulose product into a three-dimensional compressed fibre structure in a pressing operation by pressing and heating one or more three-dimensional bodies of cellulose fibres in the forming mould with a forming pressure in the range of 1-600 MPa, preferably in the range of 1-100 MPa, more preferably in the range of 4-20 MPa, and with a forming temperature in the range of 60-300° C., preferably in the range of 100-200° C., more preferably in the range of 120-170° C.

Advantages with these features are that the process of forming the cellulose products can be more efficient, where cellulose products can be produced at high speeds with high quality by shaping the three-dimensional body of cellulose fibres before dry-forming the cellulose product into a three-dimensional compressed fibre structure in the forming mould. The handling of the cellulose fibres is simplified with the at least one three-dimensional body of cellulose fibres, and the method is enabling the dry-forming of cellulose products with high finish at high production rates. The thickness of the at least one three-dimensional body is in one example substantially equal over the complete body, such that the thickness in uniform. By giving the three-dimensional body a substantially equal thickness, it is ensured that the cellulose product will meet the required specifications. The thickness of the three-dimensional body may be either substantially uniform and equal over the complete body or may vary over the body. The one or more shaping elements arranged on the movable support structure is enabling a more efficient product forming unit and method for producing high-quality cellulose products is achieved, which especially is suitable for forming deep drawn products. The three-dimensional surfaces of the one or more shaping elements are defined as non-planar surfaces having a three-dimensional shape for an efficient forming of the three-dimensional bodies of cellulose fibres. The three-dimensional surfaces have a surface configuration adapted to the configuration of the forming mould for an efficient positioning of the three-dimensional bodies of cellulose fibres in the forming mould without larger deformations. The three-dimensional surfaces of the one or more shaping elements may have any suitable three-dimensional configuration. Suitably, the three-dimensional surfaces have a shape corresponding to or similar to the forming mould, and thus to a shape corresponding to or similar to a final shape of the cellulose product formed in the forming mould. In this way, the shape of the three-dimensional bodies of cellulose fibres suitably have a shape corresponding to or similar to the forming mould, and thus to a shape corresponding to or similar to a final shape of the cellulose product formed in the forming mould. The three-dimensional surface of the shaping element has a shape corresponding to a shape of a three-dimensional pressing surface of the forming mould for an efficient forming process. This is for example desired if deep drawn products are formed. With the expression corresponding shape is meant that the three-dimensional surface of the shaping element and at least one three-dimensional pressing surface of the forming mould, have three-dimensional shapes that are similar in configuration, resulting in the forming of a three-dimensional body of cellulose fibres that fits in the forming mould without large deformations. It should be understood that the three-dimensional surface of the shaping element and at least one three-dimensional pressing surface of the forming mould may or may not be identical, but at least arranged with corresponding three-dimensional shapes for an efficient positioning of the three-dimensional body of cellulose fibres in the forming mould.

In one embodiment, the three-dimensional surface is an outer surface of the one or more shaping elements. The one or more shaping elements further comprise an inner surface opposite the outer surface, and the one or more shaping elements comprise a plurality of suction openings connecting the outer surface and the inner surface. The method further comprises the steps: arranging the loose and separated cellulose fibres onto the three-dimensional surface of the one or more shaping elements by means of the flow of air for air-forming the three-dimensional body of cellulose fibres, and applying a negative pressure via the suction openings for distributing the cellulose fibres onto the three-dimensional surface. The suction openings are enabling efficient deposition of the cellulose fibres onto the three-dimensional surface, and the negative pressure applied is securing a desired distribution of the cellulose fibres. The suction openings may have any suitable shape, size and configuration. The shape and/or size of the suction openings may vary between different parts of the shaping element, as well as the number of suction openings arranged in the shaping element.

In one embodiment, the one or more shaping elements are arranged as three-dimensional net structures or as a solid perforated structures. These constructions are providing an efficient distribution of cellulose fibres onto the three-dimensional surface, while allowing the flow of air to pass through the shaping element.

In one embodiment, the movable support structure is configured as a rotating support structure. The method further comprises the steps: displacing the one or more shaping elements to the fibre outlet by rotational movement of the support structure, and displacing the one or more shaping elements with the at least one air-formed three-dimensional body of cellulose fibres away from the fibre outlet by rotational movement of the support structure. The rotating support structure is enabling an efficient forming process for the three-dimensional bodies of cellulose fibres.

In one embodiment, the movable support structure is configured as an endless circulating support structure. The method further comprises the steps: displacing the one or more shaping elements to the fibre outlet by circulating movement of the support structure, and displacing the one or more shaping elements with the at least one air-formed three-dimensional body of cellulose fibres away from the fibre outlet by circulating movement of the support structure. The endless circulating support structure is enabling an efficient forming process for the three-dimensional bodies of cellulose fibres.

In one embodiment, the product forming unit further comprises a feeding unit. The forming mould comprises one or more first mould parts and corresponding one or more second mould parts. The method further comprises the steps: feeding one or more air-formed three-dimensional bodies of cellulose fibres from the one or more shaping elements to the forming mould by means of the feeding unit, and arranging the one or more three-dimensional bodies of cellulose fibres into a position between the one or more first mould parts and corresponding one or more second mould parts; applying the forming pressure by pressing the one or more three-dimensional bodies of cellulose fibres between the one or more first mould parts and corresponding one or more second mould parts, and applying the forming temperature onto the one or more three-dimensional bodies of cellulose fibres in the forming mould. The feeding unit is efficiently feeding the air-formed three-dimensional bodies of cellulose fibres from the one or more shaping elements to the forming mould. The first mould parts and the corresponding second mould parts are in this way cooperating for efficiently forming the cellulose product from the at least one three-dimensional body of cellulose fibres by applying the forming pressure and forming temperature.

In one embodiment, the feeding unit comprises the one or more first mould parts. With this configuration, an efficient forming process is achieved, without the need for transporting the at least one three-dimensional body of cellulose fibres from the feeding unit to the forming mould.

In one embodiment, the forming mould comprises one or more first mould parts and corresponding one or more seconds mould parts. The one or more shaping elements are configured as the one or more first mould parts. The method further comprises the steps: applying the forming pressure by pressing the one or more three-dimensional bodies of cellulose fibres between the one or more first mould parts and the corresponding one or more second mould parts, and applying the forming temperature onto the one or more three-dimensional bodies of cellulose fibres in the forming mould. In this way, the three-dimensional bodies of cellulose fibres are formed directly in the forming mould before pressing the cellulose products in the forming mould. The first mould parts are cooperating with the second mould parts, and the first mould parts and second mould parts are cooperating for efficiently forming the cellulose product from the three-dimensional bodies of cellulose fibres.

In one embodiment, the method further comprises the step: compacting the at least one three-dimensional body of cellulose fibres before dry-forming the cellulose product in the forming mould. By compacting the three-dimensional body of cellulose fibres before dry-forming the cellulose product in the forming mould, the three-dimensional body of cellulose fibres is easier to transport from the shaping element to the forming mould. The compacting operation is compressing the fibre structure of the three-dimensional body of cellulose fibres into a more dense structure, without influencing the general three-dimensional shape.

The disclosure further concerns a product forming unit configured for dry-forming a three-dimensional cellulose product from cellulose fibres. The product forming unit comprises a fibre transporting unit, a shaping unit, and a forming mould. The shaping unit comprises one or more shaping elements having a three-dimensional surface. The shape of the shaping element corresponds to the shape of the forming mould, and thus to the shape of the final cellulose product formed in the forming mould. The one or more shaping elements are arranged on a movable support structure. The transporting unit is configured for feeding loose and separated cellulose fibres by means of a flow of air to a fibre outlet of the fibre transporting unit, and feeding the cellulose fibres from the fibre outlet to the shaping unit by means of the flow of air as carrying medium for the cellulose fibres. The support structure is configured for displacing the one or more shaping elements to the fibre outlet for arranging the loose and separated cellulose fibres onto the three-dimensional surfaces of the one or more shaping elements by means of the flow of air for air-forming at least one three-dimensional body of cellulose fibres which may have a substantially uniform thickness or may vary over the length of the body, and displacing the one or more shaping elements with the at least one air-formed three-dimensional body of cellulose fibres away from the fibre outlet by movement of the support structure. The three-dimensional surfaces of the one or more shaping elements have a shape corresponding to a shape of a three-dimensional pressing surface of the forming mould. The forming mould is configured for dry-forming the cellulose product into a three-dimensional compressed fibre structure in a pressing operation by pressing and heating one or more three-dimensional bodies of cellulose fibres in the forming mould with a forming pressure in the range of 1-600 MPa, preferably in the range of 1-100 MPa, more preferably in the range of 4-20 MPa, and with a forming temperature T_{F} in the range of 60-300° C., preferably in the range of 100-200° C., more preferably in the range of 120-170° C.

Advantages with these features are that the process of forming the cellulose products can be more efficient, where cellulose products can be produced at high speeds with high quality by shaping the three-dimensional body of cellulose fibres before dry-forming the cellulose product into a three-dimensional compressed fibre structure in the forming mould. The thickness of the at least one three-dimensional body may be substantially equal over the complete body or may vary over the complete body. By giving the three-dimensional body a substantially equal thickness, it is ensured that the cellulose product will meet the required specifications. By giving the three-dimensional body a varying thickness over the complete body, the required forming pressure may be optimized. The handling of the cellulose fibres is simplified with the at least one three-dimensional body of cellulose fibres, and the method is enabling the dry-forming of cellulose products with high finish at high production rates. The one or more shaping elements arranged on the movable support structure is enabling a more efficient product forming unit and method for producing high-quality cellulose products is achieved, which especially is suitable for forming deep drawn products. The three-dimensional surfaces of the one or more shaping elements are defined as non-planar surfaces having a three-dimensional shape for an efficient forming of the three-dimensional bodies of cellulose fibres. The three-dimensional surfaces have a surface configuration adapted to the configuration of the forming mould for an efficient positioning of the three-dimensional bodies of cellulose fibres in the forming mould without larger deformations. By forming the three-dimensional body of cellulose fibres with a shape that corresponds to the forming mould, and with a uniform thickness, the forming pressure can be held at a low level.

The three-dimensional surfaces of the one or more shaping elements may have any suitable three-dimensional configuration. Suitably, the three-dimensional surfaces have a shape corresponding to or similar to a final shape of the cellulose product formed in the forming mould. In this way, the shape of the three-dimensional bodies of cellulose fibres suitably have a shape corresponding to or similar to a final shape of the cellulose product formed in the forming mould. The three-dimensional surface of the shaping element has a shape corresponding to a shape of a three-dimensional pressing surface of the forming mould for an efficient forming process. This is for example desired if deep drawn products are formed. With the expression corresponding shape is meant that the three-dimensional surface of the shaping element and at least one three-dimensional pressing surface of the forming mould, have three-dimensional shapes that are similar in configuration, resulting in the forming of a three-dimensional body of cellulose fibres that fits in the forming mould without large deformations. It should be understood that the three-dimensional surface of the shaping element and at least one three-dimensional pressing surface of the forming mould may or may not be identical, but at least arranged with corresponding three-dimensional shapes for an efficient positioning of the three-dimensional body of cellulose fibres in the forming mould.

In one embodiment, the three-dimensional surface is an outer surface of the one or more shaping elements. The one or more shaping elements further comprise an inner surface opposite the outer surface. The one or more shaping elements comprise a plurality of suction openings connecting the outer surface and the inner surface. The three-dimensional surface is configured for receiving loose and separated cellulose fibres by means of the flow of air for air-forming the three-dimensional body of cellulose fibres upon application of a negative pressure via the suction openings for distributing the cellulose fibres onto the three-dimensional surface. The suction openings are enabling efficient deposition of the cellulose fibres onto the three-dimensional surface, and the negative pressure applied is securing a desired distribution of the cellulose fibres. The suction openings may have any suitable shape, size and configuration. The shape and/or size of the suction openings may vary between different parts of the shaping element, as well as the number of suction openings arranged in the shaping element.

In one embodiment, the one or more shaping elements are arranged as a three-dimensional net structures or as solid perforated structures. These constructions are providing an efficient distribution of cellulose fibres onto the three-dimensional surface, while allowing the flow of air to pass through the shaping element.

In one embodiment, the movable support structure is arranged as a rotating support structure configured for displacing the one or more shaping elements to the fibre outlet by rotational movement of the support structure, and configured for displacing the one or more shaping elements with the at least one air-formed three-dimensional body of cellulose fibres away from the fibre outlet by rotational movement of the support structure. The rotating support structure is enabling an efficient forming process for the three-dimensional bodies of cellulose fibres.

In one embodiment, the movable support structure is arranged as an endless circulating support structure configured for displacing the one or more shaping elements to the fibre outlet by circulating movement of the support structure, and configured for displacing the one or more shaping elements with the at least one air-formed three-dimensional body of cellulose fibres away from the fibre outlet by circulating movement of the support structure. The endless circulating support structure is enabling an efficient forming process for the three-dimensional bodies of cellulose fibres.

In one embodiment, the product forming unit further comprises a feeding unit. The forming mould comprises one or more first mould parts and corresponding one or more second mould parts. The feeding unit is configured for feeding one or more air-formed three-dimensional bodies of cellulose fibres from the one or more shaping elements to the forming mould for arranging the one or more three-dimensional bodies of cellulose fibres into a position between the one or more first mould parts and corresponding one or more second mould parts. The forming mould is configured for applying the forming pressure by pressing the one or more three-dimensional bodies of cellulose fibres between the one or more first mould parts and corresponding one or more second mould parts, and applying the forming temperature onto the one or more three-dimensional bodies of cellulose fibres. The feeding unit is efficiently feeding the air-formed three-dimensional bodies of cellulose fibres from the one or more shaping elements to the forming mould. The first mould parts and the corresponding second mould parts are in this way cooperating for efficiently forming the cellulose product from the at least one three-dimensional body of cellulose fibres by applying the forming pressure and forming temperature.

In one embodiment, the feeding unit comprises the one or more first mould parts. With this configuration, an efficient forming process is achieved, without the need for transporting the at least one three-dimensional body of cellulose fibres from the feeding unit to the forming mould.

In one embodiment, the forming mould comprises one or more first mould parts and corresponding one or more seconds mould parts. The one or more shaping elements are configured as the one or more first mould parts. The forming mould is configured for applying the forming pressure by pressing the one or more three-dimensional bodies of cellulose fibres between the one or more first mould parts and the corresponding one or more second mould parts, and applying the forming temperature onto the one or more three-dimensional bodies of cellulose fibres in the forming mould. In this way, the three-dimensional bodies of cellulose fibres are formed directly in the forming mould before pressing the cellulose products in the forming mould. The first mould parts are cooperating with the second mould parts, and the first mould parts and second mould parts are cooperating for efficiently forming the cellulose product from the three-dimensional bodies of cellulose fibres.

It should be noted that for all the above embodiments and examples, the three-dimensional surfaces of the one or more shaping elements could be either generally positive or generally negative in shape. In this context, positive means that the three-dimensional surface is intended to create a generally concave surface of the cellulose product. Here, negative means that the three-dimensional surface is intended to create a generally convex surface of the cellulose product. However, the three-dimensional surface can vary within its generally positive or negative shape such that portions of the surface can be locally positive and locally negative thereby creating an at least in part undulating shape of the cellulose product.

The disclosure further concerns a three-dimensional cellulose product comprising compressed loose and separated cellulose fibres, wherein the cellulose product comprises at least two air-formed three-dimensional bodies of cellulose fibres being attached to each other.

### BRIEF DESCRIPTION OF DRAWINGS

The disclosure will be described in detail in the following, with reference to the attached drawings, in which

FIG. 1a-c show schematically, in side views, an embodiment of a product forming unit comprising a fibre transporting unit, shaping elements arranged on a movable support structure, a feeding unit, and a forming mould, according to the disclosure,

FIG. 2a-b show schematically, in perspective views from above, the shaping element and an alternative embodiment of the shaping element, according to the disclosure,

FIG. 3a-c show schematically, in side views, an embodiment of a product forming unit comprising a fibre transporting unit, shaping elements arranged on a movable support structure, a feeding unit, and a forming mould, according to the disclosure,

FIG. 4a-b show schematically, in side views, an embodiment of a product forming unit comprising a fibre transporting unit, shaping elements arranged on a movable support structure, a feeding unit, and a forming mould, according to the disclosure,

FIG. 5a-b show schematically, in side views, an embodiment of a product forming unit comprising a fibre transporting unit, shaping elements arranged on a movable support structure, a feeding unit, and a forming mould, according to the disclosure,

FIG. 6a-b show schematically, in side views, an embodiment of a product forming unit comprising a fibre transporting unit, shaping elements arranged on a movable support structure, and a forming mould, according to the disclosure, and

FIG. 7a-b show schematically, in front views, the shaping elements with the movable support structure in different embodiments, according to the disclosure.

### DESCRIPTION OF EXAMPLE EMBODIMENTS

Various aspects of the disclosure will hereinafter be described in conjunction with the appended drawings to illustrate and not to limit the disclosure, wherein like designations denote like elements, and variations of the described aspects are not restricted to the specifically shown embodiments, but are applicable on other variations of the disclosure.

In the figures, different embodiments of a product forming unit U are schematically illustrated, in which cellulose products 1 are dry-formed from cellulose fibres CF. The product forming unit U comprises a fibre transporting unit T, a shaping unit S, and a forming mould M. The shaping unit S comprises one or more shaping elements 2 arranged on a movable support structure 11. The fibre transporting unit T is used for feeding loose and separated cellulose fibres CF into a flow of air A, and for transporting the cellulose fibres CF to the one or more shaping elements 2 arranged on the movable support structure 11 by means of the flow of air A as carrying medium for the cellulose fibres CF.

With the expression cellulose product 1 is meant a product that is dry-formed in the forming mould M from the cellulose fibres CF. The dry-formed cellulose product 1 may be a final product ready for use in a specific application. Alternatively, the dry-formed cellulose product 1 may be a pre-formed part of a final product and thus constitute a part of an assembled final product. One or more pre-formed parts may for example be attached to each other with glue or other fastening means into a final product. In this way, the cellulose product is configured as a three-dimensional cellulose product comprising compressed loose and separated cellulose fibres, where the cellulose product comprises at least two air-formed three-dimensional bodies of cellulose fibres attached to each other.

With the expression loose and separated cellulose fibres CF is meant cellulose fibres that are separated from each other and loosely arranged relative to each other, or cellulose fibres or cellulose fibre bundles that are separated from each other and loosely arranged relative to each other.

The cellulose fibres CF may originate from a suitable cellulose raw material, such as a pulp material. Suitable pulp materials are for example fluff pulp, paper structures, or other cellulose fibre containing structures. The pulp material is preferably pure cellulose fibres, e.g. from chemically treated pulp, where most of the lignin and the hemicellulose is removed. The cellulose fibres may also be extracted from agricultural waste materials, for example wheat straws, fruit and vegetable peels, bagasse, or from other suitable sources. When for example using pulp as raw material for the cellulose fibres CF, the pulp structure commonly needs to be separated in a separating unit, such as a suitable mill unit, before feeding the loose and separated cellulose fibres CF into the flow of air A. In the separating unit, the pulp structure is separated into individual cellulose fibres, or into individual cellulose fibres and cellulose fibre bundles, and the better milling process the more individual cellulose fibres are formed. In other embodiments, only individual cellulose fibres may be used as raw material. The loose and separated cellulose fibres CF may be provided by a mill unit arranged in connection to the product forming unit U, or alternatively pre-prepared loose and separated cellulose fibres CF are provided to the product forming unit U.

The fibre transporting unit T is further used for arranging the loose and separated cellulose fibres CF onto a three-dimensional surface S_{3D} of the one or more shaping elements 2 by means of the flow of air A for forming at least one three-dimensional body B of cellulose fibres CF. In this way, the at least one three-dimensional body B of cellulose fibres CF is air-formed in a dry and controlled fibre forming process in which the cellulose fibres CF are air-formed onto the three-dimensional surfaces S_{3D} of the one or more shaping elements 2 by means of the flow of air A as carrying medium for the cellulose fibres CF. The thickness of the at least one three-dimensional body may be substantially equal and uniform over the complete body B. By giving the three-dimensional body B a substantially equal thickness, it is ensured that the cellulose product will meet the required specifications. It should be understood that even if the at least one three-dimensional body B of cellulose fibres CF is slightly compacted before the forming of the cellulose products 1, such as compacting the at least one three-dimensional body B for feeding or transportation purposes, the at least one three-dimensional body B still comprises loose and separated cellulose fibres CF.

A three-dimensional surface S_{3D} of the at least one shaping element 2 is defined as a non-planar surface having a three-dimensional shape for an efficient forming of the three-dimensional body B of cellulose fibres CF. The three-dimensional surface S_{3D} of the at least one shaping element 2 has a surface configuration adapted to the configuration of the forming mould for an efficient positioning of the three-dimensional body B of cellulose fibres CF in the forming mould M without larger deformations. The three-dimensional surface S_{3D} of the at least one shaping element 2 may have any suitable three-dimensional configuration, and the three-dimensional surface S_{3D} may for example be arranged with elevated, undulating, rounded and/or step-like surface sections. Suitably, the three-dimensional surface S_{3D} of the at least one shaping element 2 has a shape corresponding to or similar to a final shape of the cellulose product 1 formed in the forming mould M. In this way, the shape of the three-dimensional body B of cellulose fibres CF suitably has a shape corresponding to or similar to the forming mould, and thus to a shape corresponding to or similar to a final shape of the cellulose product 1 formed in the forming mould M.

With an air-formed three-dimensional body B of cellulose fibres CF is meant an essentially air-formed fibrous structure produced from cellulose fibres CF, where cellulose fibres CF are carried and formed to the three-dimensional body B of cellulose fibres CF by air as carrying medium. This is different from a normal papermaking process or a traditional wet-forming process, where water is used as carrying medium for the cellulose fibres when forming the paper or fibre structure. In the air-forming process, small amounts of water or other substances may if desired be added to the cellulose fibres in order to change the properties of the cellulose products, but air is still used as carrying medium in the forming process. The small amount of water has the advantage of enabling forming of hydrogen bonds between the fibres in the forming mould when subjected to pressure and temperature. The hydrogen bonds are an important factor for rigidity of the cellulose product.

According to one example, at least one three-dimensional body B of cellulose fibres CF may have a moisture content in the range of 4-15 wt %, preferably in the range of 6-10 wt %, when arranged in the forming mould M.

The three-dimensional body B of cellulose fibres CF may have a composition where the fibres are of the same origin or alternatively contain a mix of two or more types of cellulose fibres, depending on the desired properties of the cellulose products 1. The cellulose fibres CF used in the three-dimensional body B of cellulose fibres CF are during the forming process of the cellulose products 1 strongly bonded to each other. The cellulose fibres CF may be mixed with other substances or compounds to a certain amount. With cellulose fibres is meant any type of cellulose fibres, such as natural cellulose fibres or manufactured cellulose fibres. The three-dimensional body B of cellulose fibres CF may specifically comprise at least 95% cellulose fibres, or more specifically at least 99% cellulose fibres. However, the three-dimensional body B of cellulose fibres CF may have other suitable configurations and cellulose fibre amounts.

The forming mould M is used for dry-forming the cellulose products 1 into a three-dimensional compressed fibre structure CF_{CS} by pressing and heating at least one three-dimensional body B of cellulose fibres CF in the forming mould M with a forming pressure P_{F} in the range of 1-600 MPa, preferably in the range of 1-100 MPa, more preferably in the range of 4-20 MPa, and a forming temperature T_{F} in the range of 60-300° C., preferably in the range of 100-200° C., more preferably in the range of 120-170° C. The forming pressure P_{F} may selectively be higher in specific parts or areas of the forming mould M. This higher forming pressure P_{F} may be used for forming sections of the cellulose product 1 having a higher stiffness.

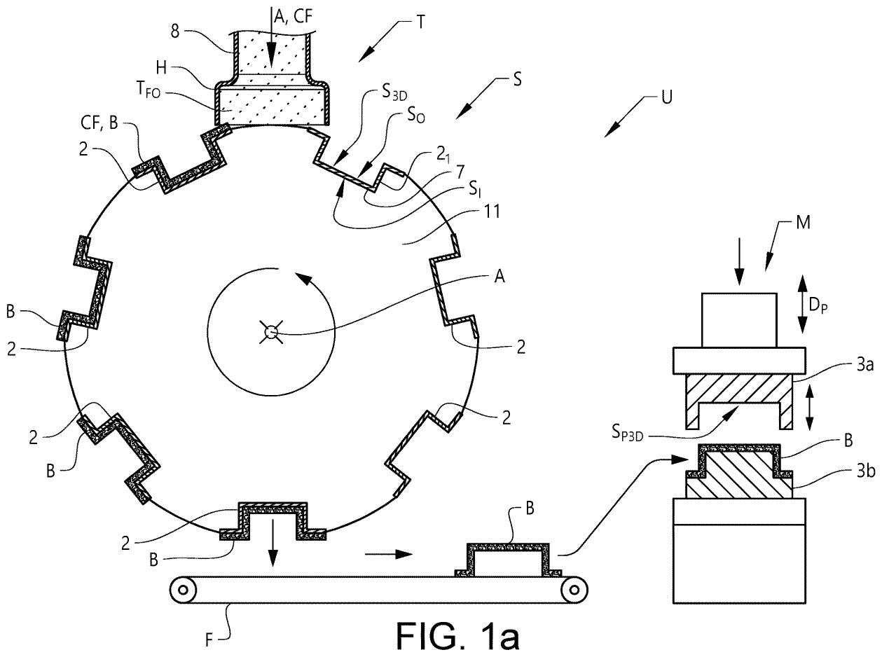

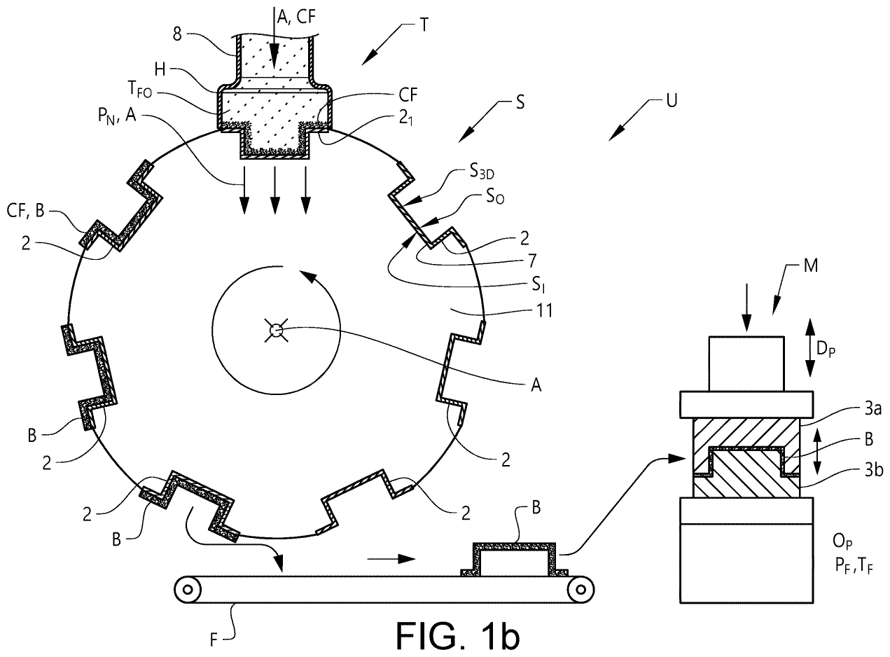

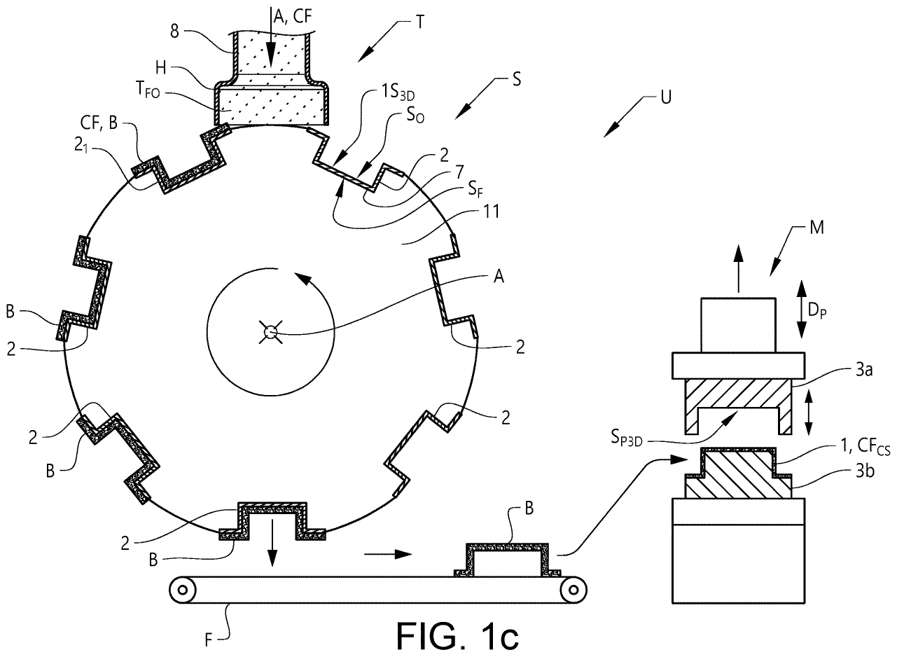

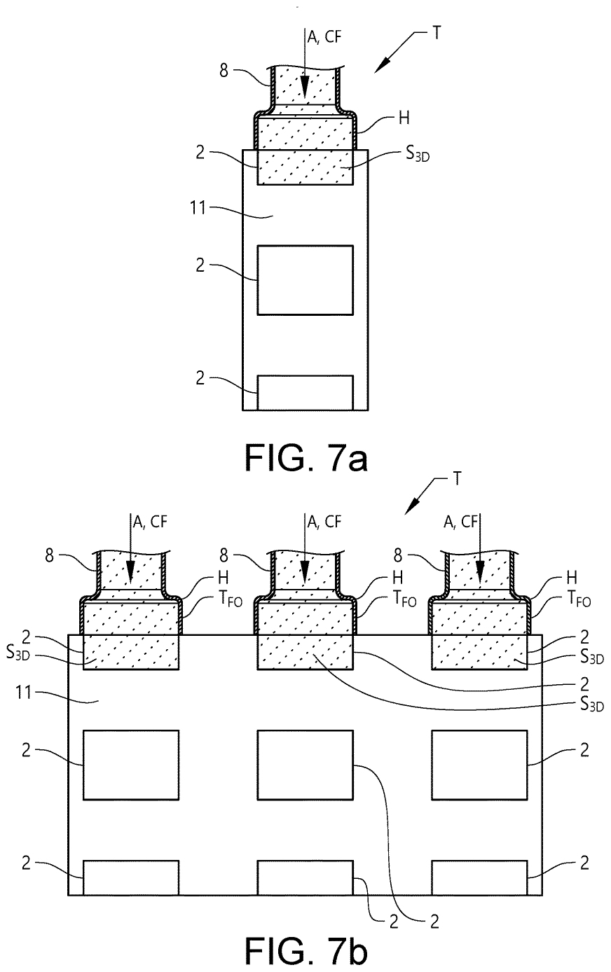

FIGS. 1a-c schematically show an embodiment of a product forming unit U in which cellulose products 1 are dry-formed from cellulose fibres CF. The product forming unit U comprises a fibre transporting unit T, a shaping unit S, and a forming mould M. The shaping unit S comprises a plurality of shaping elements 2 arranged on a movable support structure 11. In the illustrated embodiment, the movable support structure 11 is configured as a rotating support structure having a wheel-like configuration. A front view of the movable support structure 11 is schematically illustrated in FIG. 7a. The fibre transporting unit T is used for feeding loose and separated cellulose fibres CF into a flow of air A, and for transporting the cellulose fibres CF to the shaping elements 2 by means of the flow of air A as carrying medium for the cellulose fibres CF.

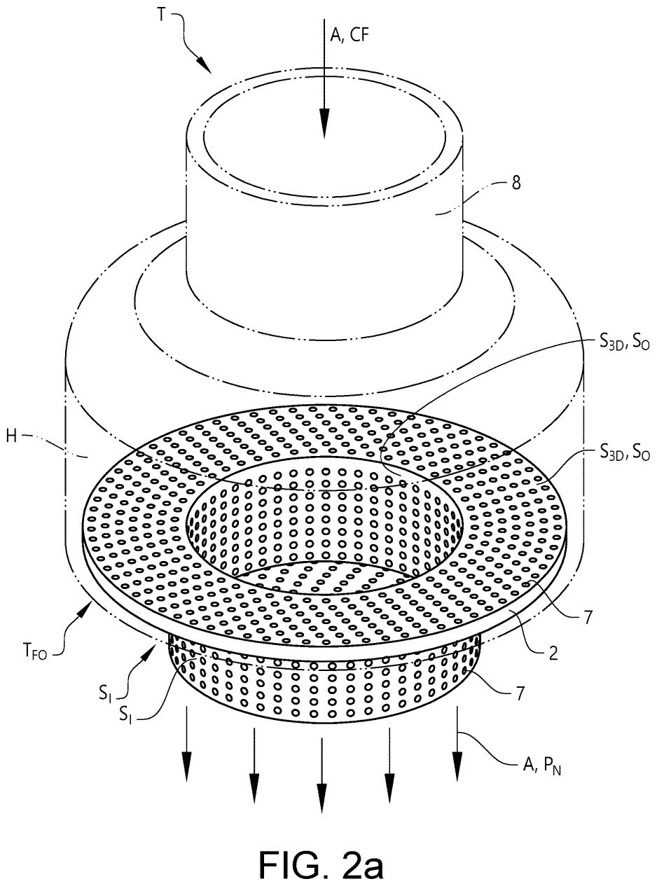

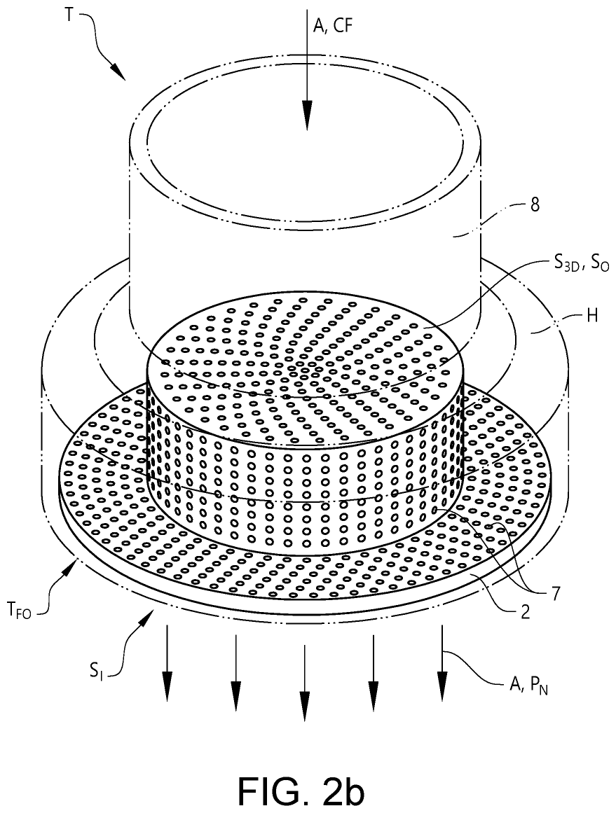

The shaping elements 2 are illustrated in FIG. 2a, and each shaping element 2 comprises a three-dimensional surface S_{3D}. A three-dimensional body B of cellulose fibres CF is formed onto the three-dimensional surface S_{3D} from the cellulose fibres CF transported by the flow of air A to the shaping element 2, as will be further described below. The shaping elements 2 may have any suitable three-dimensional shape and configuration, such as for example shapes with male and/or female configurations. In FIG. 2a, a shaping element 2 with a female configuration is schematically illustrated, and in FIG. 2b, an alternative embodiment of a shaping element 2 with a male configuration is schematically illustrated. The shape of the shaping element corresponds to the shape of the forming mould M.

In the embodiment shown in FIGS. 1a-c, the fibre transporting unit T comprises a flow channel 8 in which a flow of air A is introduced, for example by a suitable fan unit or other air flow establishing device of the fibre transporting unit T. The shaping elements 2 are arranged in connection to the flow channel 8 upon forming of the three-dimensional body B of cellulose fibres CF to enable the distribution of cellulose fibres CF to the shaping elements 2. The transporting unit T comprises a fibre outlet T_{FO}, and the fibre outlet T_{FO} is suitably arranged in connection to the flow channel 8. The fibre outlet T_{FO} may be configured as a hood H or similar arrangement, for an efficient distribution of cellulose fibres CF onto the shaping elements 2. Loose and separated cellulose fibres CF are introduced into the flow of air A for forming a mix of air and cellulose fibres CF that are transported by means of the flow of air A in the flow channel 8. The loose and separated cellulose fibres CF are in this way fed in the fibre transporting unit T by means of a flow of air A to the fibre outlet T_{FO} of the fibre transporting unit T.

In other non-illustrated embodiments, two or more flow channels 8 may be arranged in connection to the movable support structure 11, for feeding different types of cellulose fibres CF to the shaping elements 2. In this way, air-forming of the three-dimensional bodies B of cellulose fibres CF with layers of different cellulose fibres CF is enabled.

In some embodiments, a non-illustrated mill unit may be arranged in connection to the flow channel 8. The mill unit may be used for both separating cellulose raw material into loose and separated cellulose fibres CF and establishing the flow of air A in the flow channel 8. A mix of cellulose fibres CF into the flow of air A may be established directly by the mill unit.

As indicated in FIGS. 1a-c, the fibre transporting unit T is feeding the loose and separated cellulose fibres CF in the flow channel 8 to the three-dimensional surface S_{3D} of the shaping elements 2 by means of the flow of air A.

As shown in FIG. 2a, the three-dimensional surface S_{3D} is an outer surface S_{O} of the shaping element 2. In this embodiment, the shaping element 2 further comprises an inner surface S_{I} opposite the outer surface S_{O}, and a plurality of suction openings 7 connecting the outer surface S_{O} and the inner surface S_{I}. The three-dimensional surface S_{3D} of the shaping element 2 is configured for receiving the loose and separated cellulose fibres CF by means of the flow of air A for forming the three-dimensional body B of cellulose fibres CF upon application of a negative pressure P_{N} via the suction openings 7 for distributing the cellulose fibres CF onto the three-dimensional surface S_{3D}, as schematically illustrated in FIG. 1b. The shaping element 2 may suitably be arranged as a three-dimensional net structure or as a solid perforated structure. The suction openings 7 may have any suitable shape, size and configuration. The shape and/or size of the suction openings 7 may vary between different parts of the shaping element 2, as well as the number of suction openings 7 arranged in the shaping element 2. Depending on the geometry of the shaping element, the suction openings may be arranged such that the thickness of the resulting three-dimensional body B is either substantially uniform and equal over the complete body or is varying over the extension of the body.

The forming of the three-dimensional body B of cellulose fibres CF is sequentially illustrated in FIGS. 1a-c. As indicated with the arrow in the figures, the movable support structure 11 is rotating around a rotational axis A. Upon rotational movement of the movable support structure 11, the plurality of shaping elements 2 are transported past the fibre outlet T_{FO} of the fibre transporting unit T.

In other non-illustrated embodiments, the shaping elements 2 are only partly arranged with suction openings 7 for steering and controlling the flow of cellulose fibres CF.

In further non-illustrated embodiments, the shaping elements 2 may be arranged without the suction openings, and the cellulose fibres CF are deposited onto the three-dimensional surface S_{3D} of the shaping elements 2 without the need for applying a negative pressure through the shaping elements 2. In this way, the cellulose fibres CF are instead shot or sprayed onto the three-dimensional surface S_{3D} by a flow of air A as carrying medium for the cellulose fibres CF.

In the following, the movement of a specific first shaping element 2₁ will be described more in detail in connection to FIGS. 1a-c. In the position shown in FIG. 1a, the first shaping element 2₁ is arranged upstream the fibre outlet T_{FO} of the fibre transporting unit T. In this position, the first shaping element 2₁ is empty and ready for receiving cellulose fibres CF. Upon rotational movement of the movable support structure 11, the first shaping element 2₁ is transported towards the fibre outlet T_{FO}, as understood from FIGS. 1a-b. The air-forming of the three-dimensional body B of cellulose fibres CF is suitably taking place upon a continuous movement of the first shaping element 2₁ past the fibre outlet T_{FO}. In the position shown in FIG. 1b, the first shaping element 2₁ is arranged in direct connection to the fibre outlet T_{FO}, and upon movement of the first shaping element 2₁ past the fibre outlet T_{FO} loose and separated cellulose fibres CF are deposited onto the three-dimensional surface S_{3D}. In this way, the first shaping element 2₁ is displaced to the fibre outlet T_{FO} by movement of the support structure 11 upon feeding of the loose and separated cellulose fibres CF from the fibre outlet T_{FO} to the first shaping element 2₁ by means of the flow of air A as carrying medium for the cellulose fibres CF, and the three-dimensional body B of cellulose fibres CF is built up on the three-dimensional surface S_{3D}. The three-dimensional surface S_{3D} of the first shaping element 2₁ is receiving the loose and separated cellulose fibres CF by means of the flow of air A for forming the three-dimensional body B of cellulose fibres CF upon application of a negative pressure P_{N} via the suction openings 7 for distributing the cellulose fibres CF onto the three-dimensional surface S_{3D}, as schematically illustrated in FIGS. 1b and 2a.

Alternatively, the movable support structure 11 may be intermittently operated and stopped in the position shown in FIG. 1b, in which the first shaping element 2₁ is receiving the loose and separated cellulose fibres CF by means of the flow of air A for forming the three-dimensional body B of cellulose fibres CF. Further, the cellulose fibres CF may be intermittently fed in the fibre transporting unit T and synchronized with the position of the first shaping element 2₁ in FIG. 1b.

The three-dimensional body B of cellulose fibres CF is air-formed in a dry and controlled fibre forming process in which the cellulose fibres CF are air-formed onto the three-dimensional surface S_{3D} of the first shaping element 2₁ by means of the flow of air A as carrying medium for the cellulose fibres CF when the first shaping element 2₁ is transported by the movable support structure 11 past the fibre outlet T_{FO}. When a suitable amount of cellulose fibres CF are formed onto the three-dimensional surface S_{3D}, the three-dimensional body B of cellulose fibres CF is formed. The thickness of the at least one three-dimensional body may be substantially equal over the complete body B. By giving the three-dimensional body B a substantially equal thickness, it can be ensured that the cellulose product will meet the required specifications. In the position shown in FIG. 1c, the first shaping element 2₁ is arranged downstream the fibre outlet T_{FO} of the fibre transporting unit T. As understood from FIG. 1c, the first shaping element 2₁ with the air-formed three-dimensional body B of cellulose fibres CF is transported away from the fibre outlet T_{FO} upon rotational movement of the movable support structure 11, and ready for being removed from the first shaping element 2₁ for further handling in the product forming unit U.

After forming of the three-dimensional bodies B on the three-dimensional surfaces S_{3D} of the shaping elements 2, the three-dimensional bodies B are transported from the shaping elements 2 to the forming mould M by a feeding unit F, as shown in FIGS. 1a-c. In the illustrated embodiment, the feeding unit F is arranged as a feeding belt. However, the feeding unit F may have any other suitable design and configuration, such as for example a robot arm, or other similar arrangement.

In the embodiment shown in FIGS. 1a-c, the forming mould M comprises a first mould part 3a and a second mould part 3b that are cooperating for forming the cellulose products 1 from the three-dimensional bodies B of cellulose fibres CF. The first mould part 3a and the second mould part 3b are movably arranged relative to each other, and the first mould part 3a and the second mould part 3b are configured for moving relative to each other in a pressing direction D_{P}. The second mould part 3b is stationary and the first mould part 3a is movably arranged in relation to the second mould part 3b in the pressing direction D_{P}, during a pressing operation O_{P}. As indicated with the double arrow in FIGS. 1a-c, the first mould part 3a is configured to move both towards the second mould part 3b and away from the second mould part 3b in linear movements along an axis extending in the pressing direction D_{P}.

The three-dimensional surface S_{3D} of the shaping element 2 has a shape corresponding to a shape of a three-dimensional pressing surface S_{P3D} of the forming mould M. In the embodiment illustrated in FIGS. 1a-c, the three-dimensional surface S_{3D} of the shaping element 2 has a shape corresponding to the shape of a three-dimensional pressing surface S_{P3D} of the first mould part 3a. As described above, the three-dimensional surface S_{3D} is an outer surface S_{O} of the shaping element 2. In a similar way, the three-dimensional pressing surface S_{P3D} of the first mould part 3a is arranged as an outer surface that is arranged to press the formed three-dimensional body B of cellulose fibres CF. By arranging the three-dimensional surface S_{3D} of the shaping element 2 and the three-dimensional pressing surface S_{P3D} of the first mould part 3a with corresponding shapes, an efficient cellulose product forming process is achieved. This is for example desired if deep drawn products are formed.

With the expression corresponding shape is meant that the three-dimensional surface S_{3D} of the shaping element 2 and at least one three-dimensional pressing surface S_{P3D} of the forming mould M, such as a surface in the first mould part 3a and/or the second mould part 3b, have three-dimensional shapes that are similar in configuration, resulting in the forming of a three-dimensional body B of cellulose fibres CF that fits in the forming mould M without large deformations. It should be understood that the three-dimensional surface S_{3D} of the shaping element 2 and at least one three-dimensional pressing surface S_{P3D} of the forming mould M may or may not be identical, but at least arranged with corresponding three-dimensional shapes for an efficient positioning and pressing operation O_{P} of the three-dimensional body B of cellulose fibres CF in the forming mould M.

When the three-dimensional body B of cellulose fibres CF is formed with a shape corresponding to the shape of the first mould part 3a and the second mould part 3b, as shown in FIGS. 1a-c, the dry-forming operation in the forming mould M can be made with reduced risks of weak material sections and/or cracks in the final cellulose product 1, since the dimensional body B of cellulose fibres CF will not be stretched out a major extent during the pressing operation O_{P} in the forming mould M.

It should be understood that for all embodiments according to the disclosure, the expression moving in the pressing direction D_{P} includes a movement in the pressing direction D_{P}, and the movement may take place in opposite directions. The expression may further include both linear and non-linear movements of a mould part, where the result of the movement during forming is a repositioning of the mould part in the pressing direction D_{P}.

With the expression pressing operation O_{P} is meant the operation of the mould parts for forming a cellulose product 1 from the three-dimensional body B of cellulose fibres CF. In the embodiment shown in FIGS. 1a-c, the pressing operation O_{P} starts when the first mould part 3a is moved from a stationary position. In this position, the first mould part 3a and the second mould part 3b are arranged at a distance from each other and the three-dimensional body B of cellulose fibres CF can be fed into the forming mould M in a forming position between the first mould part 3a and the second mould part 3b, as illustrated in FIG. 1a. The feeding unit F is configured for feeding the three-dimensional body B of cellulose fibres CF from the shaping element 2 into a position between the first mould part 3a and the second mould part 3b. Thereafter, the first mould part 3a is moved towards the second mould part 3b for applying the forming pressure P_{F} onto the three-dimensional body B of cellulose fibres CF, as shown in FIG. 1b. In this way, the forming mould M is applying the forming pressure P_{F} by pressing the three-dimensional body B of cellulose fibres CF between the first mould part 3a and the second mould part 3b. The forming mould M is further applying the forming temperature T_{F} onto the three-dimensional body B of cellulose fibres CF.

When the cellulose product is formed in the forming mould M, the first mould part 3a is moved away from the second mould part 3b back to the stationary position, as shown in FIG. 1c. When the first mould part 3a has reached the stationary position again, the pressing operation O_{P} is completed. The pressing operation O_{P} is thus defined as a pressing cycle during which the three-dimensional body B of cellulose fibres CF is exerted to the forming pressure P_{F}, and the duration of the pressing operation O_{P} is suitably calculated from the start of the movement of the first mould part 3a from the stationary position until the first mould part 3a has reached the stationary position again.

The forming mould M is in the pressing operation O_{P} dry-forming the cellulose product 1 into a three-dimensional compressed fibre structure CF_{CS} by pressing and heating the three-dimensional body B of cellulose fibres CF in the forming mould M with a forming pressure P_{F} in the range of 1-600 MPa, preferably in the range of 1-100 MPa, more preferably in the range of 4-20 MPa, and a forming temperature T_{F} in the range of 60-300° C., preferably in the range of 100-200° C., more preferably in the range of 120-170° C.

The forming pressure P_{F} may selectively be higher in specific parts or areas of the forming mould M. This higher forming pressure P_{F} may be used for forming sections of the cellulose product 1 having a higher stiffness.

The at least one three-dimensional body B of cellulose fibres CF may be compacted before dry-forming the cellulose product 1 in the forming mould M. By compacting the three-dimensional body B of cellulose fibres CF before dry-forming the cellulose product 1 in the forming mould M, the three-dimensional body B of cellulose fibres CF is easier to transport from the shaping element 2 to the forming mould M. The compacting operation is compressing the fibre structure of the three-dimensional body B of cellulose fibres CF into a more dense structure, without influencing the general three-dimensional shape. If two or more three-dimensional bodies B of cellulose fibres CF are arranged in connection to each other in a slightly overlapping relationship in the forming mould M, less compacted overlapping sections of the three-dimensional bodies B of cellulose fibres CF may be integrated with and attached to each other in the pressing operation O_{P}.

The forming mould M may further comprise a heating unit. The heating unit is configured for applying the forming temperature T_{F} onto the three-dimensional body B of cellulose fibres CF during the forming operation in the forming mould M. The heating unit may have any suitable configuration. The heating unit may be integrated in or cast into the first mould part 3a and/or second mould part 3b, and suitable heating devices are e.g. electrical heaters, such as resistor elements, or fluid heaters. Other suitable heat sources may also be used.

The forming pressure P_{F} may be applied to the three-dimensional body B of cellulose fibres CF in only one pressing step during the pressing operation O_{P}. Suitably, the cellulose product 1 is dry-formed into the three-dimensional compressed fibre structure CF_{CS} in a single pressing operation by pressing and heating the three-dimensional body B of cellulose fibres CF in the forming mould M with the forming pressure P_{F} and the forming temperature T_{F}. In this way, the forming pressure P_{F} and the forming temperature T_{F} are applied onto the three-dimensional body B of cellulose fibres CF during a single pressing operation upon forming of the cellulose product 1 in the forming mould M. With a single pressing operation is meant that the cellulose product 1 is formed from the three-dimensional body B of cellulose fibres CF in one single pressing step in the forming mould M. In the single pressing operation, the first mould part 3a and the second mould part 3b are interacting with each other for establishing the forming pressure P_{F} and the forming temperature T_{F} during a single operational engagement step. Thus, in the single pressing operation, the forming pressure P_{F} and the forming temperature T_{F} are not applied to the three-dimensional body B of cellulose fibres CF in two or more repeated pressing steps.

Alternatively, the forming pressure P_{F} may be applied in two or more repeated pressing steps during the pressing operation O_{P}, and in this way, the mould parts are repeatedly exerting the forming pressure P_{F} onto the three-dimensional body B of cellulose fibres CF.

It should be understood that the forming mould M may have other configurations. In alternative non-illustrated embodiments, the first mould part 3a may be stationary and the second mould part 3b movably arranged in relation to the first mould part 3a during the pressing operation O_{P}, or both the first mould part 3a and the second mould part 3b are movably arranged towards and away from each other.

The forming mould M may have a single-cavity configuration with one first mould part 3a and one second mould part 3b cooperating with each other for dry-forming the cellulose products 1. Alternatively, the forming mould M may have a multi-cavity configuration, where instead two or more first mould parts 3a are cooperating with two or more corresponding second mould parts 3b. In this way, two or more cellulose products can be produced in one pressing operation O_{P}. A single-cavity configuration forming mould M thus comprises only one first mould part 3a and a cooperating second mould part 3b. A multi-cavity configuration forming mould M comprises two or more cooperating first mould parts 3a and second mould parts 3b.

In the embodiment illustrated in FIGS. 1a-c, the forming mould M is arranged as a single-cavity configuration forming mould comprising a first mould part 3a and a second mould part 3b movably arranged relative to each other. It should be understood that even if the forming mould M is described in connection to a single-cavity configuration forming mould, the disclosure is equally applicable on multi-cavity configuration forming moulds.

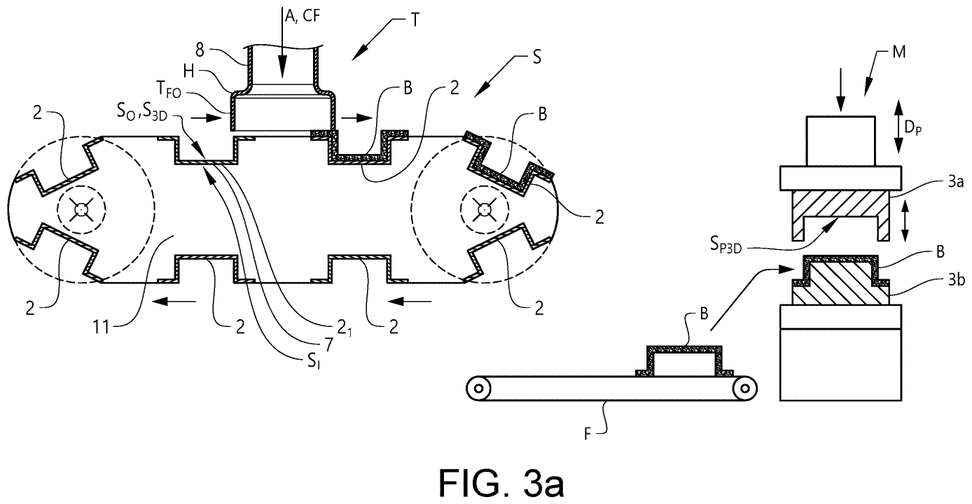

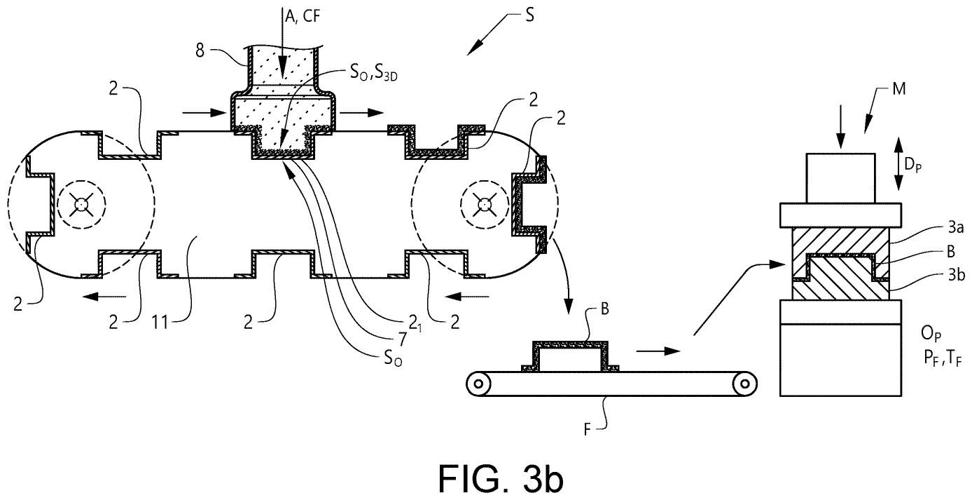

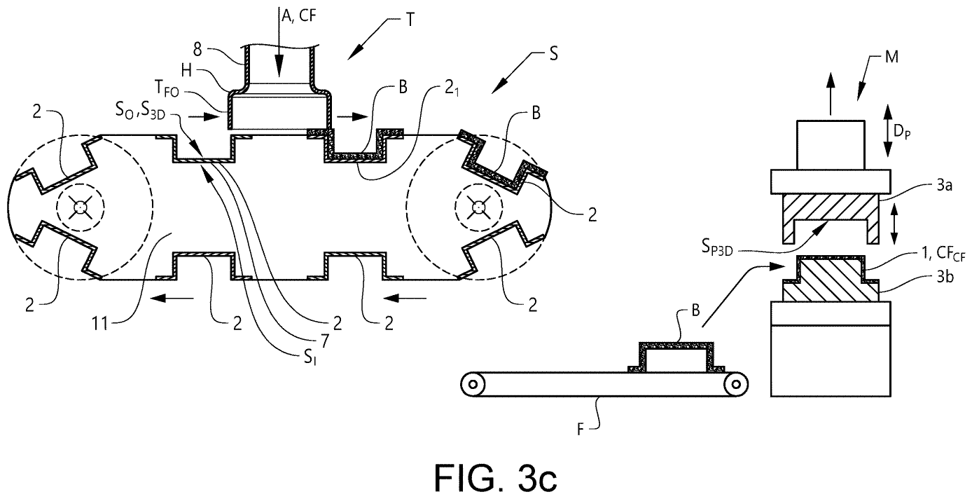

FIGS. 3a-c schematically show an alternative embodiment of a product forming unit U in which cellulose products 1 are dry-formed from cellulose fibres CF. The product forming unit U comprises a fibre transporting unit T, a shaping unit S, and a forming mould M. The shaping unit S comprises a plurality of shaping elements 2 arranged on a movable support structure 11. A front view of the movable support structure 11 is schematically illustrated in FIG. 7a. In the illustrated embodiment, the movable support structure 11 is configured as an endless circulating support structure having a belt-like configuration. The fibre transporting unit T is used for feeding loose and separated cellulose fibres CF into a flow of air A, and for transporting the cellulose fibres CF to the shaping elements 2 by means of the flow of air A as carrying medium for the cellulose fibres CF.

The shaping elements 2 are illustrated in FIG. 2a, and each shaping element 2 comprises a three-dimensional surface S_{3D}. A three-dimensional body B of cellulose fibres CF is formed onto the three-dimensional surface S_{3D} from the cellulose fibres CF transported by the flow of air A to the shaping element 2. The shaping element 2 may have any suitable three-dimensional shape and configuration.

In the embodiment shown in FIGS. 1a-c, the fibre transporting unit T comprises a flow channel 8 in which a flow of air A is introduced, for example by a suitable fan unit or other air flow establishing device of the fibre transporting unit T. The shaping elements 2 are arranged in connection to the flow channel 8 upon forming of the three-dimensional body B of cellulose fibres CF to enable the distribution of cellulose fibres CF to the shaping elements 2. The transporting unit T comprises a fibre outlet T_{FO}, and the fibre outlet T_{FO} is suitably arranged in connection to the flow channel 8. The fibre outlet T_{FO} may be configured as a hood H or similar arrangement, for an efficient distribution of cellulose fibres CF onto the shaping elements 2. Loose and separated cellulose fibres CF are introduced into the flow of air A for forming a mix of air and cellulose fibres CF that are transported by means of the flow of air A in the flow channel 8. The loose and separated cellulose fibres CF are in this way fed in the fibre transporting unit T by means of a flow of air A to the fibre outlet T_{FO} of the fibre transporting unit T.

In other non-illustrated embodiments, two or more flow channels 8 may be arranged in connection to the movable support structure 11, for feeding different types of cellulose fibres CF to the shaping elements 2. In this way, air-forming of the three-dimensional bodies B of cellulose fibres CF with layers of different cellulose fibres CF is enabled.

In some embodiments, a non-illustrated mill unit may be arranged in connection to the flow channel 8. The mill unit may be used for both separating cellulose raw material into loose and separated cellulose fibres CF and establishing the flow of air A in the flow channel 8. A mix of cellulose fibres CF into the flow of air A may be established directly by the mill unit.

As indicated in FIGS. 3a-c, the fibre transporting unit T is feeding the loose and separated cellulose fibres CF in the flow channel 8 to the three-dimensional surface S_{3D} of the shaping elements 2 by means of the flow of air A.

As shown in FIG. 2a, the three-dimensional surface S_{3D} is an outer surface S_{O} of the shaping element 2. In this embodiment, the shaping element 2 further comprises an inner surface S_{I} opposite the outer surface S_{O}, and a plurality of suction openings 7 connecting the outer surface S_{O} and the inner surface S_{I}, in the same way and with the same configuration as described above in connection to FIGS. 1a-c and 2a-b. The shape of the shaping element 2 corresponds to the shape of the forming mould M in which a cellulose product is formed.

The forming of the three-dimensional body B of cellulose fibres CF is sequentially illustrated in FIGS. 3a-c. As indicated with the arrow in the figures, the movable support structure 11 is displaced with a circulating movement, and by this circulating movement the plurality of shaping elements 2 are transported past the fibre outlet T_{FO} of the fibre transporting unit T.

In the following, the movement of a specific first shaping element 2₁ will be described more in detail in connection to FIGS. 3a-c. In the position shown in FIG. 3a, the first shaping element 2₁ is arranged upstream the fibre outlet T_{FO} of the fibre transporting unit T. In this position, the first shaping element 2₁ is empty and ready for receiving cellulose fibres CF. Upon displacement of the movable support structure 11, the first shaping element 2₁ is transported towards the fibre outlet T_{FO}, as understood from FIGS. 3a-b. The air-forming of the three-dimensional body B of cellulose fibres CF is suitably taking place upon a continuous movement of the first shaping element 2₁ past the fibre outlet T_{FO}. In the position shown in FIG. 3b, the first shaping element 2₁ is arranged in direct connection to the fibre outlet T_{FO}, and upon movement of the first shaping element 2₁ past the fibre outlet T_{FO} loose and separated cellulose fibres CF are deposited onto the three-dimensional surface S_{3D}. In this way, the first shaping element 2₁ is displaced to the fibre outlet T_{FO} by circulating movement of the support structure 11 upon feeding of the loose and separated cellulose fibres CF from the fibre outlet T_{FO} to the first shaping element 2₁ by means of the flow of air A as carrying medium for the cellulose fibres CF, and the three-dimensional body B of cellulose fibres CF is built up on the three-dimensional surface S_{3D}. The three-dimensional surface S_{3D} of the first shaping element 2₁ is receiving the loose and separated cellulose fibres CF by means of the flow of air A for forming the three-dimensional body B of cellulose fibres CF upon application of a negative pressure P_{N} via the suction openings 7 for distributing the cellulose fibres CF onto the three-dimensional surface S_{3D}, as schematically illustrated in FIGS. 3b and 2a.

Alternatively, the movable support structure 11 may be intermittently operated and stopped in the position shown in FIG. 3b, in which the first shaping element 2₁ is receiving the loose and separated cellulose fibres CF by means of the flow of air A for forming the three-dimensional body B of cellulose fibres CF. Further, the cellulose fibres CF may be intermittently fed in the fibre transporting unit T and synchronized with the position of the first shaping element 2₁ in FIG. 3b.

The three-dimensional body B of cellulose fibres CF is air-formed in a dry and controlled fibre forming process in which the cellulose fibres CF are air-formed onto the three-dimensional surface S_{3D} of the first shaping element 2₁ by means of the flow of air A as carrying medium for the cellulose fibres CF when the first shaping element 2₁ is transported by the movable support structure 11 past the fibre outlet T_{FO}. The thickness of the three-dimensional body may be substantially equal over the complete body. By giving the three-dimensional body B a substantially equal thickness, it is ensured that the cellulose product will meet the required specifications. When a suitable amount of cellulose fibres CF are formed onto the three-dimensional surface S_{3D}, the three-dimensional body B of cellulose fibres CF is formed. In the position shown in FIG. 3c, the first shaping element 2₁ is arranged downstream the fibre outlet T_{FO} of the fibre transporting unit T. As understood from FIG. 3c, the first shaping element 2₁ with the air-formed three-dimensional body B of cellulose fibres CF is transported away from the fibre outlet T_{FO} upon circulating movement of the movable support structure 11, and ready for being removed from the first shaping element 2₁ for further handling in the product forming unit U.

After forming of the three-dimensional bodies B on the three-dimensional surfaces S_{3D} of the shaping elements 2, the three-dimensional bodies B are transported from the shaping elements 2 to the forming mould M by a feeding unit F, as shown in FIGS. 3a-c. In the illustrated embodiment, the feeding unit F is arranged as a feeding belt. However, the feeding unit F may have any other suitable design and configuration, such as for example a robot arm, or other similar arrangement.

In the embodiment shown in FIGS. 3a-c, the forming mould M comprises a first mould part 3a and a second mould part 3b that are cooperating for forming the cellulose products 1 from the three-dimensional bodies B of cellulose fibres CF. The forming mould M suitably has the same configurations and is operated in pressing operations O_{P} in the same way as described above in connection to FIGS. 1a-c.

The three-dimensional surface S_{3D} of the shaping element 2 has a shape corresponding to a shape of a three-dimensional pressing surface S_{P3D} of the forming mould M. In the embodiment illustrated in FIGS. 3a-c, the three-dimensional surface S_{3D} of the shaping element 2 has a shape corresponding to the shape of a three-dimensional pressing surface S_{P3D} of the first mould part 3a. As described above, the three-dimensional surface S_{3D} is an outer surface S_{O} of the shaping element 2. In a similar way, the three-dimensional pressing surface S_{P3D} of the first mould part 3a is arranged as an outer surface that is arranged to press the formed three-dimensional body B of cellulose fibres CF. By arranging the three-dimensional surface S_{3D} of the shaping element 2 and the three-dimensional pressing surface S_{P3D} of the first mould part 3a with corresponding shapes, an efficient cellulose product forming process is achieved. This is for example desired if deep drawn products are formed.

With the expression corresponding shape is meant that the three-dimensional surface S_{3D} of the shaping element 2 and at least one three-dimensional pressing surface S_{P3D} of the forming mould M, such as a surface in the first mould part 3a and/or the second mould part 3b, have three-dimensional shapes that are similar in configuration, resulting in the forming of a three-dimensional body B of cellulose fibres CF that fits in the forming mould M without large deformations. It should be understood that the three-dimensional surface S_{3D} of the shaping element 2 and at least one three-dimensional pressing surface S_{P3D} of the forming mould M may or may not be identical, but at least arranged with corresponding three-dimensional shapes for an efficient positioning and pressing operation O_{P} of the three-dimensional body B of cellulose fibres CF in the forming mould M.

When the three-dimensional body B of cellulose fibres CF is formed with a shape corresponding to the shape of the first mould part 3a and the second mould part 3b, as shown in FIGS. 3a-c, the dry-forming operation in the forming mould M can be made with reduced risks of weak material sections and/or cracks in the final cellulose product 1, since the dimensional body B of cellulose fibres CF will not be stretched out a major extent during the pressing operation O_{P} in the forming mould M.

In FIG. 3a, the three-dimensional body B of cellulose fibres CF has been fed into the forming mould M in a forming position between the first mould part 3a and the second mould part 3b, by means of the feeding unit F. Thereafter, the first mould part 3a is moved towards the second mould part 3b for applying the forming pressure P_{F} onto the three-dimensional body B of cellulose fibres CF, as shown in FIG. 3b. The forming mould M dry-forming the cellulose product 1 into a three-dimensional compressed fibre structure CF_{CS} by pressing and heating the three-dimensional body B of cellulose fibres CF in the forming mould M with a forming pressure P_{F} in the range of 1-600 MPa, preferably in the range of 1-100 MPa, more preferably in the range of 4-20 MPa, and a forming temperature T_{F} in the range of 60-300° C., preferably in the range of 100-200° C., more preferably in the range of 120-170° C. The forming mould M may further comprise a heating unit, as described above in connection to FIGS. 1a-c. When the cellulose product is formed in the forming mould M, the first mould part 3a is moved away from the second mould part 3b, as shown in FIG. 3c.

The forming pressure P_{F} may selectively be higher in specific parts or areas of the forming mould M. This higher forming pressure P_{F} may be used for forming sections of the cellulose product 1 having a higher stiffness and thus a higher density.

The forming pressure P_{F} may selectively be higher in specific parts or areas of the forming mould M, and in certain cases, the forming pressure P_{F} applied onto the cellulose fibres CF in specific parts or areas of the forming mould M may be in the range of 1-600 MPa, preferably 4-200 MPa. This higher forming pressure P_{F} may be used for forming sections of the cellulose product 1 having a higher stiffness and thus a higher density.

The at least one three-dimensional body B of cellulose fibres CF may be compacted before dry-forming the cellulose product 1 in the forming mould M. By compacting the three-dimensional body B of cellulose fibres CF before dry-forming the cellulose product 1 in the forming mould M, the three-dimensional body B of cellulose fibres CF is easier to transport from the shaping element 2 to the forming mould M. The compacting operation is compressing the fibre structure of the three-dimensional body B of cellulose fibres CF into a more dense structure, without influencing the general three-dimensional shape. If two or more three-dimensional bodies B of cellulose fibres CF are arranged in connection to each other in a slightly overlapping relationship in the forming mould M, less compacted overlapping sections of the three-dimensional bodies B of cellulose fibres CF may be integrated with and attached to each other in the pressing operation O_{P}.

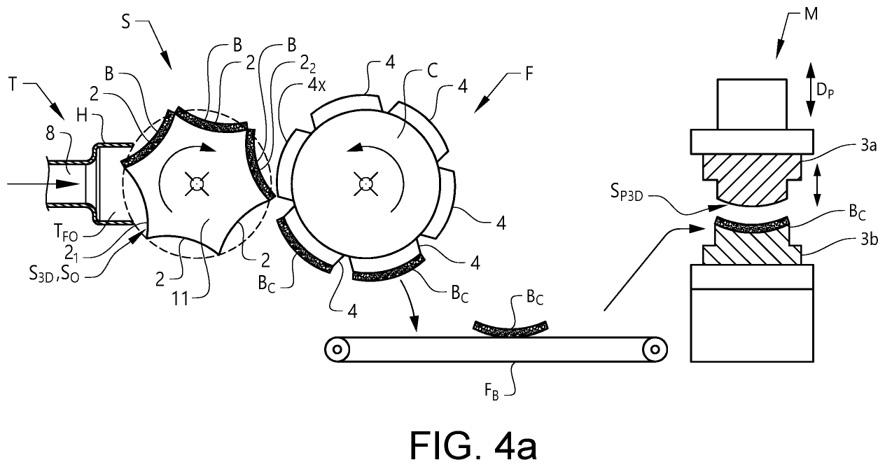

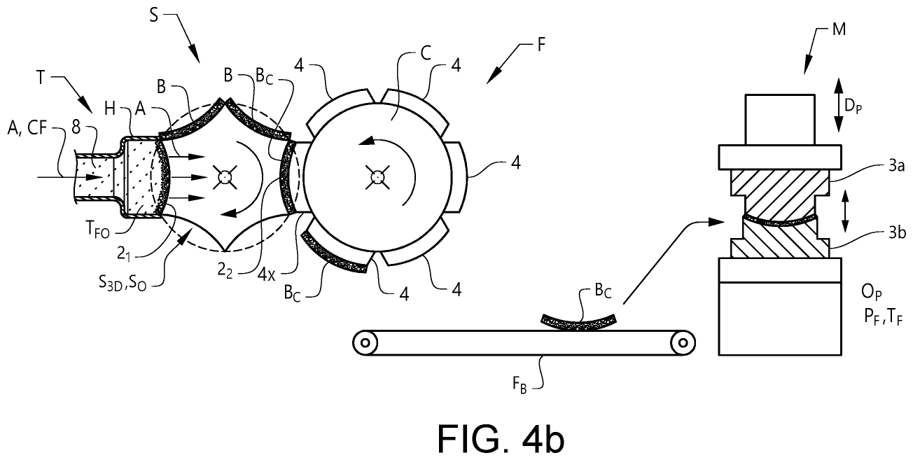

FIGS. 4a-b schematically show an alternative embodiment of a product forming unit U in which cellulose products 1 are dry-formed from cellulose fibres CF. The product forming unit U comprises a fibre transporting unit T, a shaping unit S, a feeding unit F, and a forming mould M. The shaping unit S comprises a plurality of shaping elements 2 arranged on a movable support structure 11. A front view of the movable support structure 11 is schematically illustrated in FIG. 7a. In the illustrated embodiment, the movable support structure 11 is configured as a rotating support structure having a wheel-like configuration. The fibre transporting unit T is used for feeding loose and separated cellulose fibres CF into a flow of air A, and for transporting the cellulose fibres CF to the shaping elements 2 by means of the flow of air A as carrying medium for the cellulose fibres CF. The shaping elements shown in FIG. 4a-b may have any suitable shape and configured as described in the embodiments above. The shaping elements 2 each comprises a three-dimensional surface S_{3D}. A three-dimensional body B of cellulose fibres CF is formed onto the three-dimensional surface S_{3D} from the cellulose fibres CF transported by the flow of air A to the shaping element 2. The thickness of the three-dimensional body may be substantially equal over the complete body B. By giving the three-dimensional body B a substantially equal thickness, it is ensured that the cellulose product will meet the required specifications.

In the embodiment shown in FIGS. 4a-b, the fibre transporting unit T comprises a flow channel 8 in which a flow of air A is introduced, as described in the embodiments above. The shaping elements 2 are arranged in connection to the flow channel 8 upon forming of the three-dimensional body B of cellulose fibres CF to enable the distribution of cellulose fibres CF to the shaping elements 2. The transporting unit T comprises a fibre outlet T_{FO}, and the fibre outlet T_{FO} is suitably arranged in connection to the flow channel 8. The fibre outlet T_{FO} may be configured as a hood H or similar arrangement, for an efficient distribution of cellulose fibres CF onto the shaping element 2. Loose and separated cellulose fibres CF are introduced into the flow of air A for forming a mix of air and cellulose fibres CF that are transported by means of the flow of air A in the flow channel 8.

In other non-illustrated embodiments, two or more flow channels 8 may be arranged in connection to the movable support structure 11, for feeding different types of cellulose fibres CF to the shaping elements 2. In this way, air-forming of the three-dimensional bodies B of cellulose fibres CF with layers of different cellulose fibres CF is enabled.

The feeding unit F comprises a compacting unit C and a feeding belt F_{B} for transporting the three-dimensional bodies B of cellulose fibres CF from the shaping elements to the forming mould M. The compacting unit C is used for compacting the three-dimensional bodies B of cellulose fibres CF. By compacting the three-dimensional bodies B of cellulose fibres CF before dry-forming the cellulose product 1 in the forming mould M, the three-dimensional bodies B of cellulose fibres CF is easier to transport from the shaping element 2 to the forming mould M. In the embodiment shown in FIG. 4a-b, the compacting unit C is arranged as a rotating structure with a plurality of compacting surfaces 4. The compacting unit C is rotating in a rotational direction opposite the rotational direction of the movable support structure 11, as indicated with arrows in the figures. Upon synchronized rotational movements of the movable support structure 11 and the compacting unit C, the compacting surfaces 4 meet corresponding shaping elements 2 with air-formed three-dimensional bodies B of cellulose fibres CF, as shown in FIG. 4b. When the compacting surfaces 4 meet the corresponding shaping elements 2, the air-formed three-dimensional bodies B of cellulose fibres CF are slightly compacted for an efficient further transportation to the forming mould M via the feeding belt F_{B}. It should be understood that the three-dimensional bodies B of cellulose fibres CF may have different degrees of compacting in different parts. The forming mould M may have the same configuration as described in the embodiments above.

The compacting of the three-dimensional body B of cellulose fibres CF is sequentially illustrated in FIGS. 4a-b. The movable support structure 11 is displaced with a rotational movement, and by this rotational movement, the plurality of shaping elements 2 are transported past the fibre outlet T_{FO} of the fibre transporting unit T. In the position shown in FIG. 4a, a first shaping element 2₁ is arranged upstream the fibre outlet T_{FO} of the fibre transporting unit T. In this position, the first shaping element 2₁ is empty and ready for receiving cellulose fibres CF. Upon displacement of the movable support structure 11, the first shaping element 2₁ is transported towards the fibre outlet T_{FO}, as understood from FIGS. 4a-b. The air-forming of the three-dimensional body B of cellulose fibres CF is suitably taking place upon a continuous or intermittent displacement of the first shaping element 2₁ past the fibre outlet T_{FO}. In the position shown in FIG. 4b, the first shaping element 2₁ is arranged in direct connection to the fibre outlet T_{FO}, and loose and separated cellulose fibres CF are deposited onto the three-dimensional surface S_{3D}, in the way described in the embodiments above. When a suitable amount of cellulose fibres CF are deposited onto the three-dimensional surface S_{3D}, the three-dimensional body B of cellulose fibres CF is formed, and the first shaping element 2₁ is displaced away from the fibre outlet T_{FO}. As understood from FIGS. 4a-b, the first shaping element 2₁ with the air-formed three-dimensional body B of cellulose fibres CF is transported away from the fibre outlet T_{FO} upon rotating movement of the movable support structure 11, and ready for being removed from the shaping element 2 for further handling in the product forming unit U.

After forming of the three-dimensional bodies B on the three-dimensional surfaces S_{3D} of the shaping elements 2, the three-dimensional bodies B of cellulose fibres CF are transported from the shaping elements 2 to the feeding belt F_{B} by means of the compacting unit C, as shown in FIGS. 4a-b. However, the feeding unit F may have any other suitable design and configuration, such as for example a robot arm, or other similar arrangement instead of a feeding belt. In the position shown in FIG. 4a, a second shaping element 2₂ with a three-dimensional body B of cellulose fibres CF is arranged upstream a compacting position in which the three-dimensional body B of cellulose fibres CF is about to be compacted between the second shaping element 2₂ and a corresponding compacting surface 4_{X}. In this position, the corresponding compacting surface 4_{X} is empty and ready for receiving the three-dimensional body B of cellulose fibres CF from the second shaping element 2₂. Upon rotational movements of the movable support structure 11 and compacting unit C respectively, the three-dimensional body B of cellulose fibres CF is compacted between the second shaping element 2₂ and the corresponding compacting surface 4_{X}, as shown in FIG. 4b. After the compacting operation between the second shaping element 2₂ and the corresponding compacting surface 4_{X}, the compacted three-dimensional body B_{C} of cellulose fibres CF is transferred to the corresponding compacting surface 4_{X}, as understood from FIGS. 4a-b. The compacted three-dimensional body B_{C} of cellulose fibres CF is suitable held in place onto the corresponding compacting surface 4_{X} by means of suction or gripping members arranged on the compacting unit C. As understood from FIGS. 4a-b, the corresponding compacting surface 4_{X} with the compacted three-dimensional body B_{C} of cellulose fibres CF is transported away from the movable support structure 11 upon rotating movement of the compacting unit C, and ready for being removed from the corresponding compacting surface 4_{X} for further handling in the product forming unit U.

After compacting, the compacted three-dimensional body B_{C} of cellulose fibres CF is transported from the compacting unit C to the forming mould M by the feeding belt F_{B}, as understood from FIGS. 4a-b.

In the embodiment shown in FIGS. 4a-b, the forming mould M comprises a first mould part 3a and a second mould part 3b that are cooperating for forming the cellulose products 1 from the three-dimensional bodies B of cellulose fibres CF. The forming mould M suitably has the same configurations and is operated in pressing operations O_{P} in the same way as described in the embodiments above.

The three-dimensional surface S_{3D} of the shaping elements 2 has a shape corresponding to a shape of a three-dimensional pressing surface S_{P3D} of the forming mould M. In the embodiment illustrated in FIGS. 4a-b, the three-dimensional surface S_{3D} of the shaping element 2 has a shape corresponding to the shape of a three-dimensional pressing surface S_{P3D} of the first mould part 3a. As described above, the three-dimensional surface S_{3D} is an outer surface S_{O} of the shaping element 2. In a similar way, the three-dimensional pressing surface S_{P3D} of the first mould part 3a is arranged as an outer surface that is arranged to press the formed three-dimensional body B of cellulose fibres CF. By arranging the three-dimensional surface S_{3D} of the shaping element 2 and the three-dimensional pressing surface S_{P3D} of the first mould part 3a with corresponding shapes, an efficient cellulose product forming process is achieved. This is for example desired if deep drawn products are formed.

With the expression corresponding shape is meant that the three-dimensional surface S_{3D} of the shaping element 2 and at least one three-dimensional pressing surface S_{P3D} of the forming mould M, such as a surface in the first mould part 3a and/or the second mould part 3b, have three-dimensional shapes that are similar in configuration, resulting in the forming of a three-dimensional body B of cellulose fibres CF that fits in the forming mould M without large deformations. It should be understood that the three-dimensional surface S_{3D} of the shaping element 2 and at least one three-dimensional pressing surface S_{P3D} of the forming mould M may or may not be identical, but at least arranged with corresponding three-dimensional shapes for an efficient positioning and pressing operation O_{P} of the three-dimensional body B of cellulose fibres CF in the forming mould M.

When the three-dimensional body B of cellulose fibres CF is formed with a shape corresponding to the shape of the first mould part 3a and the second mould part 3b, as shown in FIGS. 4a-b, the dry-forming operation in the forming mould M can be made with reduced risks of weak material sections and/or cracks in the final cellulose product 1, since the dimensional body B of cellulose fibres CF will not be stretched out a major extent during the pressing operation O_{P} in the forming mould M.

In FIG. 4a, the three-dimensional body B of cellulose fibres CF has been fed into the forming mould M in a forming position between the first mould part 3a and the second mould part 3b, by means of the feeding belt F_{B}. Thereafter, the first mould part 3a is moved towards the second mould part 3b for applying the forming pressure P_{F} onto the three-dimensional body B of cellulose fibres CF, as shown in FIG. 4b. The forming mould M dry-forming the cellulose product 1 into a three-dimensional compressed fibre structure CF_{CS} by pressing and heating the three-dimensional body B of cellulose fibres CF in the forming mould M with a forming pressure P_{F} in the range of 1-600 MPa, preferably in the range of 1-100 MPa, more preferably in the range of 4-20 MPa, and a forming temperature T_{F} in the range of 60-300° C., preferably in the range of 100-200° C., more preferably in the range of 120-170° C. The forming mould M may further comprise a heating unit, as described above in connection to FIGS. 1a-c. When the cellulose product is formed in the forming mould M, the first mould part 3a is moved away from the second mould part 3b. The forming pressure P_{F} may selectively be higher in specific parts or areas of the forming mould M. This higher forming pressure P_{F} may be used for forming sections of the cellulose product 1 having a higher stiffness and thus a higher density.

In other non-illustrated embodiments, two or more three-dimensional bodies B of cellulose fibres CF may be arranged in connection to each other in a slightly overlapping relationship in the forming mould M, and less compacted overlapping sections of the three-dimensional bodies B of cellulose fibres CF may be integrated with and attached to each other in the pressing operation O_{P}.

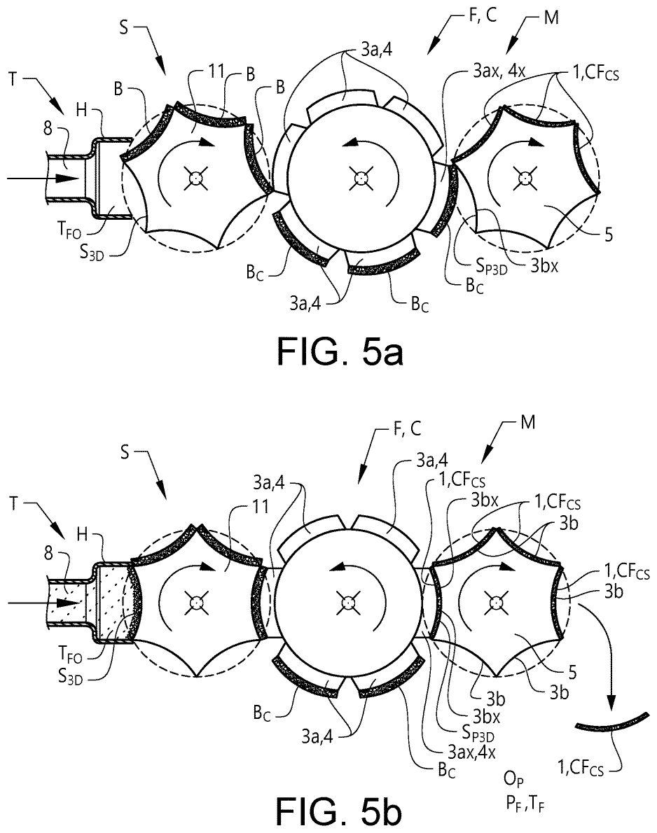

FIGS. 5a-b schematically show an alternative embodiment of a product forming unit U in which cellulose products 1 are dry-formed from cellulose fibres CF. The product forming unit U comprises a fibre transporting unit T, a shaping unit S, a feeding unit F, and a forming mould M. The shaping unit S comprises a plurality of shaping elements 2 arranged on a movable support structure 11. A front view of the movable support structure 11 is schematically illustrated in FIG. 7a. In the illustrated embodiment, the movable support structure 11 is configured as a rotating support structure having a wheel-like configuration. The fibre transporting unit T is used for feeding loose and separated cellulose fibres CF into a flow of air A, and for transporting the cellulose fibres CF to the shaping elements 2 by means of the flow of air A as carrying medium for the cellulose fibres CF. The shaping elements shown in FIG. 5a-b may have any suitable shape and configured as described in the embodiments above. The shaping elements 2 each comprises a three-dimensional surface S_{3D}. A three-dimensional body B of cellulose fibres CF is formed onto the three-dimensional surface S_{3D} from the cellulose fibres CF transported by the flow of air A to the shaping element 2, in the same way as described above in connection to FIGS. 4a-b. The thickness of the three-dimensional body may be substantially equal and uniform over the complete body or may vary over the complete body.

In the embodiment shown in FIGS. 5a-b, the fibre transporting unit T comprises a flow channel 8 in which a flow of air A is introduced, as described in the embodiments above. The shaping elements 2 are arranged in connection to the flow channel 8 upon forming of the three-dimensional body B of cellulose fibres CF to enable the distribution of cellulose fibres CF to the shaping elements 2. The transporting unit T comprises a fibre outlet T_{FO}, and the fibre outlet T_{FO} is suitably arranged in connection to the flow channel 8. The fibre outlet T_{FO} may be configured as a hood H or similar arrangement, for an efficient distribution of cellulose fibres CF onto the shaping element 2. Loose and separated cellulose fibres CF are introduced into the flow of air A for forming a mix of air and cellulose fibres CF that are transported by means of the flow of air A in the flow channel 8.

In other non-illustrated embodiments, two or more flow channels 8 may be arranged in connection to the movable support structure 11, for feeding different types of cellulose fibres CF to the shaping elements 2. In this way, air-forming of the three-dimensional bodies B of cellulose fibres CF with layers of different cellulose fibres CF is enabled.

The feeding unit F is arranged as a compacting unit C for compacting the three-dimensional bodies B of cellulose fibres CF, in the same way as described above in connection to FIGS. 4a-b. Further, the feeding unit F is arranged with a plurality of first mould parts 3a, and in this way, the feeding unit F is also forming part of the forming mould M. By compacting the three-dimensional bodies B of cellulose fibres CF before dry-forming the cellulose product 1 in the forming mould M, the three-dimensional bodies B of cellulose fibres CF is easier to transport from the shaping element 2 to the forming mould M. In the embodiment shown in FIG. 5a-b, the feeding unit F is arranged as a rotating structure with a plurality of compacting surfaces 4, which compacting surfaces 4 at least partly constitute the first mould parts 3a. The feeding unit F is rotating in a rotational direction opposite the rotational direction of the movable support structure 11, as indicated with arrows in the figures. Upon synchronized rotational movements of the movable support structure 11 and the compacting unit C, the compacting surfaces 4 meet corresponding shaping elements 2 with air-formed three-dimensional bodies B of cellulose fibres CF, as shown in FIG. 5b. When the compacting surfaces 4 meet the corresponding shaping elements 2, the air-formed three-dimensional bodies B of cellulose fibres CF are slightly compacted for an efficient further transportation to the forming mould M. It should be understood that the three-dimensional bodies B of cellulose fibres CF may have different degrees of compacting in different parts.

In the embodiment shown in FIGS. 5a-b, the forming mould M is arranged as a rotating forming mould. The forming mould M comprises the rotating feeding unit F and a corresponding rotating forming structure 5. The feeding unit F is arranged with a plurality of first mould parts 3a, and the rotating forming structure 5 is arranged with corresponding second mould parts 3b. The rotating feeding unit F and the corresponding rotating forming structure 5 are arranged to rotate in opposite directions in synchronized movements, where the first mould parts 3a meet corresponding second mould parts 3b upon the synchronized rotational movements, as understood from FIGS. 5a-b.

After forming of the three-dimensional bodies B on the three-dimensional surfaces S_{3D} of the shaping elements 2, the three-dimensional bodies B of cellulose fibres CF are transported from the shaping elements 2 to the forming mould M by means of rotational movement of the feeding unit F. In the position shown in FIG. 5a, a first mould part 3a_{X} carrying a compacted three-dimensional body B_{C} of cellulose fibres CF and a corresponding second mould part 3b_{X} are arranged upstream a pressing operation O_{P} in which the three-dimensional body B of cellulose fibres CF is about to be pressed between the first mould part 3a_{X} and corresponding second mould part 3b_{X}. Upon rotational movements of the feeding unit F and the rotating forming structure 5, the three-dimensional body B of cellulose fibres CF is dry-formed between the first mould part 3a_{X} and corresponding second mould part 3b_{X}, as shown in FIG. 5b. After the pressing operation O_{P} between the first mould part 3a_{X} and corresponding second mould part 3b_{X}, the dry-formed cellulose product 1 can be removed from the forming mould M. The rotational movements of the feeding unit F and the rotating forming structure 5 are suitably continuous. However, the rotational movements may instead be intermittent and for example stopped in the position shown in FIG. 5b if desired.

In FIGS. 5a-b, the three-dimensional body B of cellulose fibres CF is during the rotational movement of the feeding unit F and the rotating forming structure 5 fed through the forming mould M in the pressing operation O_{P} between the first mould part 3a_{X} and the corresponding second mould part 3b_{X}. During the feeding of the three-dimensional body B of cellulose fibres CF in the pressing operation O_{P} between the first mould part 3a_{X} and the corresponding second mould part 3b_{X}, the cellulose product 1 is dry-formed into a three-dimensional compressed fibre structure CF_{CS} by pressing and heating the three-dimensional body B of cellulose fibres CF in the forming mould M with a forming pressure P_{F} in the range of 1-600 MPa, preferably in the range of 1-100 MPa, more preferably in the range of 4-20 MPa, and a forming temperature T_{F} in the range of 60-300° C., preferably in the range of 100-200° C., more preferably in the range of 120-170° C. The forming pressure P_{F} may selectively be higher in specific parts or areas of the forming mould M. This higher forming pressure P_{F} may be used for forming sections of the cellulose product 1 having a higher stiffness.

The three-dimensional surface S_{3D} of the shaping elements 2 has a shape corresponding to a shape of a three-dimensional pressing surface S_{P3D} of the forming mould M. In the embodiment illustrated in FIGS. 5a-b, the three-dimensional surface S_{3D} of the shaping element 2 has a shape corresponding to the shape of a three-dimensional pressing surface S_{P3D} of the second mould part 3b. As described above, the three-dimensional surface S_{3D} is an outer surface S_{O} of the shaping element 2. In a similar way, the three-dimensional pressing surface S_{P3D} of the second mould part 3b is arranged as an outer surface that is arranged to press the formed three-dimensional body B of cellulose fibres CF. By arranging the three-dimensional surface S_{3D} of the shaping element 2 and the three-dimensional pressing surface S_{P3D} of the second mould part 3b with corresponding shapes, an efficient cellulose product forming process is achieved. This is for example desired if deep drawn products are formed.

With the expression corresponding shape is meant that the three-dimensional surface S_{3D} of the shaping element 2 and at least one three-dimensional pressing surface S_{P3D} of the forming mould M, such as a surface in the first mould part 3a and/or the second mould part 3b, have three-dimensional shapes that are similar in configuration, resulting in the forming of a three-dimensional body B of cellulose fibres CF that fits in the forming mould M without large deformations. It should be understood that the three-dimensional surface S_{3D} of the shaping element 2 and at least one three-dimensional pressing surface S_{P3D} of the forming mould M may or may not be identical, but at least arranged with corresponding three-dimensional shapes for an efficient positioning and pressing operation O_{P} of the three-dimensional body B of cellulose fibres CF in the forming mould M.

When the three-dimensional body B of cellulose fibres CF is formed with a shape corresponding to the shape of the first mould part 3a and the second mould part 3b, as shown in FIGS. 5a-b, the dry-forming operation in the forming mould M can be made with reduced risks of weak material sections and/or cracks in the final cellulose product 1, since the dimensional body B of cellulose fibres CF will not be stretched out a major extent during the pressing operation O_{P} in the forming mould M.

The forming mould M may further comprise a heating unit. The heating unit is configured for applying the forming temperature T_{F} onto the three-dimensional body B of cellulose fibres CF during the forming operation in the forming mould M. The heating unit may have any suitable configuration. The heating unit may be integrated in or cast into the first mould parts 3a and/or second mould parts 3b, and suitable heating devices are e.g. electrical heaters, such as resistor elements, or fluid heaters. Other suitable heat sources may also be used.

In other non-illustrated embodiments, two or more three-dimensional bodies B of cellulose fibres CF may be arranged in connection to each other in a slightly overlapping relationship in the forming mould M, and less compacted overlapping sections of the three-dimensional bodies B of cellulose fibres CF may be integrated with and attached to each other in the pressing operation O_{P}.

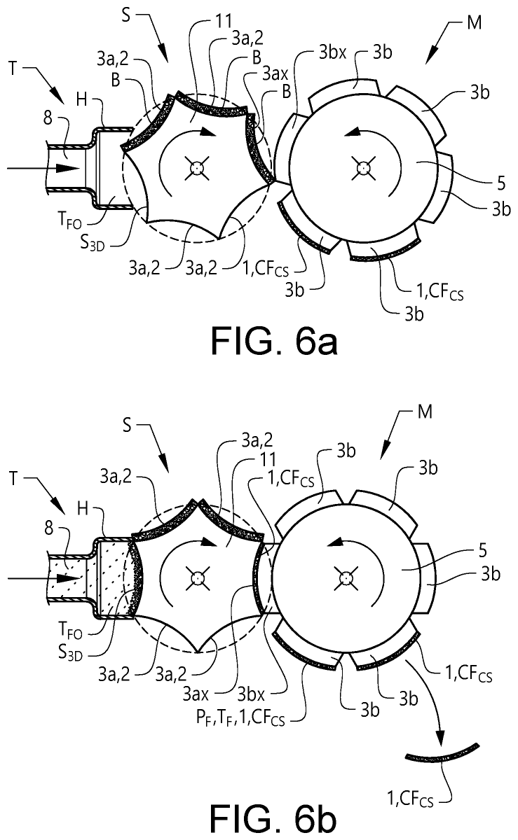

FIGS. 6a-b schematically show an alternative embodiment of a product forming unit U in which cellulose products 1 are dry-formed from cellulose fibres CF. The product forming unit U comprises a fibre transporting unit T, a shaping unit S, and a forming mould M. The shaping unit S comprises a plurality of shaping elements 2 arranged on a movable support structure 11. A front view of the movable support structure 11 is schematically illustrated in FIG. 7a. In the illustrated embodiment, the movable support structure 11 is configured as a rotating support structure having a wheel-like configuration. The fibre transporting unit T is used for feeding loose and separated cellulose fibres CF into a flow of air A, and for transporting the cellulose fibres CF to the shaping elements 2 by means of the flow of air A as carrying medium for the cellulose fibres CF. The shaping elements shown in FIG. 6a-b may have any suitable shape and configured as described in the embodiments above. The shaping elements 2 each comprises a three-dimensional surface S_{3D}. A three-dimensional body B of cellulose fibres CF is formed onto the three-dimensional surface S_{3D} from the cellulose fibres CF transported by the flow of air A to the shaping element 2, in the same way as described above in connection to FIGS. 4a-b. The thickness of the three-dimensional body may be substantially equal and uniform over the complete body or may vary over the complete body.

In the embodiment shown in FIGS. 6a-b, the fibre transporting unit T comprises a flow channel 8 in which a flow of air A is introduced, as described in the embodiments above. The shaping elements 2 are arranged in connection to the flow channel 8 upon forming of the three-dimensional body B of cellulose fibres CF to enable the distribution of cellulose fibres CF to the shaping elements 2. The transporting unit T comprises a fibre outlet T_{FO}, and the fibre outlet T_{FO} is suitably arranged in connection to the flow channel 8. The fibre outlet T_{FO} may be configured as a hood H or similar arrangement, for an efficient distribution of cellulose fibres CF onto the shaping element 2. Loose and separated cellulose fibres CF are introduced into the flow of air A for forming a mix of air and cellulose fibres CF that are transported by means of the flow of air A in the flow channel 8.

In other non-illustrated embodiments, two or more flow channels 8 may be arranged in connection to the movable support structure 11, for feeding different types of cellulose fibres CF to the shaping elements 2. In this way, air-forming of the three-dimensional bodies B of cellulose fibres CF with layers of different cellulose fibres CF is enabled.

In the embodiment shown in FIGS. 6a-b, the forming mould M is arranged as a rotating forming mould. The forming mould M comprises the rotating shaping unit S and a corresponding rotating forming structure 5. In this way, the shaping unit S together with the rotating forming structure 5 are constituting the rotating forming mould. The forming mould M comprises a plurality of first mould parts 3a and corresponding seconds mould parts 3b. In this embodiment, the one or more shaping elements 2 arranged on the movable support structure 11 are configured as the first mould parts 3a, and the rotating forming structure 5 is arranged with corresponding second mould parts 3b. By configuring the shaping elements 2 as the first mould parts 3a of the forming mould M, the three-dimensional bodies B of cellulose fibres CF are formed directly in the forming mould M before pressing the cellulose product 1 in the forming mould M. The rotating shaping unit S and the corresponding rotating forming structure 5 are arranged to rotate in opposite directions in synchronized movements, where the first mould parts 3a meet corresponding second mould parts 3b upon the synchronized rotational movements, as understood from FIGS. 6a-b.

The movable support structure 11 is rotating in a rotational direction opposite the rotational direction of the rotating forming structure 5, as indicated with arrows in the figures. Upon synchronized rotational movements of the movable support structure 11 and the rotating forming structure 5, the shaping elements 2 arranged as the first mould parts 3a with air-formed three-dimensional bodies B of cellulose fibres CF meet corresponding second mould parts 3b, as shown in FIG. 6b.

After forming of the three-dimensional bodies B on the three-dimensional surfaces S_{3D} of the shaping elements 2 arranged as the first mould parts 3a, the three-dimensional bodies B of cellulose fibres CF are transported towards the second mould parts 3b by the rotational movement of the movable support structure 11. In the position shown in FIG. 6a, a first mould part 3a_{X} carrying a three-dimensional body B of cellulose fibres CF and a corresponding second mould part 3b_{X} are arranged upstream a pressing operation O_{P} in which the three-dimensional body B of cellulose fibres CF is about to be pressed between the first mould part 3a_{X} and corresponding second mould part 3b_{X}. Upon rotational movements of the shaping unit S and the rotating forming structure 5, the three-dimensional body B of cellulose fibres CF is dry-formed between the first mould part 3a_{X} and corresponding second mould part 3b_{X}, as shown in FIG. 6b. In the pressing operation O_{P}, the forming pressure P_{F} is applied by pressing the three-dimensional body B of cellulose fibres CF between the first mould part 3a_{X} and the corresponding second mould part 3b_{X}. Further, the forming temperature T_{F} is applied onto the three-dimensional bodies B of cellulose fibres CF in the forming mould M. After the pressing operation O_{P} between the first mould part 3a_{X} and corresponding second mould part 3b_{X}, the dry-formed cellulose product 1 can be removed from the forming mould M. The rotational movements of the shaping unit S and the rotating forming structure 5 are suitably continuous. However, the rotational movements may instead be intermittent and for example stopped in the position shown in FIG. 6b if desired.

In FIGS. 6a-b, the three-dimensional body B of cellulose fibres CF is during the rotational movement of the shaping unit S and the rotating forming structure 5 fed through the forming mould M in the pressing operation O_{P} between the first mould part 3a_{X} and the corresponding second mould part 3b_{X}. During the feeding of the three-dimensional body B of cellulose fibres CF in the pressing operation O_{P} between the first mould part 3a_{X} and the corresponding second mould part 3b_{X}, the cellulose product 1 is dry-formed into a three-dimensional compressed fibre structure CF_{CS} by pressing and heating the three-dimensional body B of cellulose fibres CF in the forming mould M with a forming pressure P_{F} in the range of 1-600 MPa, preferably in the range of 1-100 MPa, more preferably in the range of 4-20 MPa, and a forming temperature T_{F} in the range of 60-300° C., preferably in the range of 100-200° C., more preferably in the range of 120-170° C. The forming pressure P_{F} may selectively be higher in specific parts or areas of the forming mould M. This higher forming pressure P_{F} may be used for forming sections of the cellulose product 1 having a higher stiffness.

The three-dimensional surface S_{3D} of the shaping elements 2 has a shape corresponding to a shape of a three-dimensional pressing surface S_{P3D} of the forming mould M. In the embodiment illustrated in FIGS. 6a-b, the three-dimensional surface S_{3D} of the shaping element 2 is constituting a three-dimensional pressing surface S_{P3D} of the first mould part 3a. As described above, the three-dimensional surface S_{3D} is an outer surface S_{O} of the shaping element 2, and thus the three-dimensional pressing surface S_{P3D} of the first mould part 3a is arranged as an outer surface that is arranged to press the formed three-dimensional body B of cellulose fibres CF. By arranging the three-dimensional surface S_{3D} of the shaping element 2 and the three-dimensional pressing surface S_{P3D} of the second mould part 3b with corresponding shapes, an efficient cellulose product forming process is achieved. This is for example desired if deep drawn products are formed.

With the expression corresponding shape is meant that the three-dimensional surface S_{3D} of the shaping element 2 and at least one three-dimensional pressing surface S_{P3D} of the forming mould M, such as a surface in the first mould part 3a and/or the second mould part 3b, have three-dimensional shapes that are similar in configuration, resulting in the forming of a three-dimensional body B of cellulose fibres CF that fits in the forming mould M without large deformations. It should be understood that in this embodiment the three-dimensional surface S_{3D} of the shaping element 2 and the three-dimensional pressing surface S_{P3D} of the first mould part 3a is constituted by the same surface and thus are identical.

When the three-dimensional body B of cellulose fibres CF is formed with a shape corresponding to the shape of the first mould part 3a and the second mould part 3b, as shown in FIGS. 6a-b, the dry-forming operation in the forming mould M can be made with reduced risks of weak material sections and/or cracks in the final cellulose product 1, since the dimensional body B of cellulose fibres CF will not be stretched out a major extent during the pressing operation O_{P} in the forming mould M.

The forming mould M may further comprise a heating unit. The heating unit is configured for applying the forming temperature T_{F} onto the three-dimensional body B of cellulose fibres CF during the forming operation in the forming mould M. The heating unit may have any suitable configuration. The heating unit may be integrated in or cast into the first mould parts 3a and/or second mould parts 3b, and suitable heating devices are e.g. electrical heaters, such as resistor elements, or fluid heaters. Other suitable heat sources may also be used.

The movable support structure 11 may have a single-row configuration, as shown in FIG. 7a, where a plurality of shaping elements 2 are arranged after each other on the movable support structure 11 in a single row. Alternatively, the movable support structure 11 may have a multi-row configuration, as shown in FIG. 7b, where a plurality of shaping elements 2 are arranged after each other on the movable support structure 11 in two or more rows. In this way, a two or more shaping elements 2 are arranged in connection to each other for simultaneous forming of a plurality of three-dimensional bodies B of cellulose fibres CF, as shown in FIG. 7b. The fibre transporting unit T is feeding loose and separated cellulose fibres CF in a plurality of flow channels 8 to the three-dimensional surfaces S_{3D} of the shaping elements 2 by means of a flow of air A. By arranging the loose and separated cellulose fibres CF onto the three-dimensional surfaces S_{3D}, the three-dimensional bodies B of cellulose fibres CF is built up on each of the three-dimensional surfaces S_{3D} in the same way as described above. In this way, the three-dimensional bodies B of cellulose fibres CF are air-formed in a dry and controlled fibre forming process in which the cellulose fibres CF are air-formed onto the three-dimensional surfaces S_{3D} of the shaping elements 2 by means of the flow of air A as carrying medium for the cellulose fibres CF. After forming, the three-dimensional bodies B of cellulose fibres CF are transported to the forming mould M.

In other non-illustrated embodiments, cellulose fibres CF may also be arranged onto the movable support structure 11 between the shaping elements 2 for forming a fibre structure with three-dimensional bodies B of cellulose fibres CF connected to each other by cellulose fibres CF. This will result in a structure with interlinked three-dimensional bodies B of cellulose fibres CF for simple transport from the shaping unit S to the forming mould M.

It will be appreciated that the above description is merely exemplary in nature and is not intended to limit the present disclosure, its application or uses. While specific examples have been described in the specification and illustrated in the drawings, it will be understood by those of ordinary skill in the art that various changes may be made and equivalents may be substituted for elements thereof without departing from the scope of the present disclosure as defined in the claims. Furthermore, modifications may be made to adapt a particular situation or material to the teachings of the present disclosure without departing from the essential scope thereof. Therefore, it is intended that the present disclosure not be limited to the particular examples illustrated by the drawings and described in the specification as the best mode presently contemplated for carrying out the teachings of the present disclosure, but that the scope of the present disclosure will include any embodiments falling within the foregoing description and the appended claims. Reference signs mentioned in the claims should not be seen as limiting the extent of the matter protected by the claims, and their sole function is to make claims easier to understand.

### REFERENCE SIGNS

1: Cellulose product
2: Shaping element
3a: First mould part
3b: Second mould part
4: Compacting surfaces
5: Forming structure
7: Suction opening
8: Flow channel
11: Movable support structure
A: Air
A_{R}: Rotational axis
B: Three-dimensional body
C: Compacting unit
CF: Cellulose fibres
CF_{CS}: Compressed fibre structure
F: Feeding unit
F_{B}: Feeding belt
H: Hood
M: Forming mould
O_{P}: Pressing operation
P_{F}: Forming pressure
S: Shaping unit
S_{3D}: Three-dimensional surface
S_{I}: Inner surface
S_{O}: Outer surface
S_{P3D}: Three-dimensional pressing surface
T: Fibre transporting unit
T_{F}: Forming temperature
T_{FO}: Fibre outlet
U: Product forming unit

1. A method for dry-forming a three-dimensional cellulose product from cellulose fibres in a product forming unit, wherein the product forming unit comprises a fibre transporting unit, a shaping unit, and a forming mould,
wherein the shaping unit comprises one or more shaping elements having a three-dimensional surface, wherein the one or more shaping elements are arranged on a movable support structure, wherein the method comprises the steps of:
providing loose and separated cellulose fibres to the fibre transporting unit, and feeding the loose and separated cellulose fibres in the fibre transporting unit by means of a flow of air to a fibre outlet of the fibre transporting unit;
displacing the one or more shaping elements to the fibre outlet by movement of the support structure upon feeding of the loose and separated cellulose fibres from the fibre outlet to the one or more shaping elements by means of the flow of air as carrying medium for the cellulose fibres, and arranging the loose and separated cellulose fibres onto the three-dimensional surfaces of the one or more shaping elements by means of the flow of air for air-forming at least one three-dimensional body of cellulose fibres having a shape corresponding to or similar to the forming mould, wherein the three-dimensional surfaces of the one or more shaping elements have a shape corresponding to a shape of a three-dimensional pressing surface of the forming mould;
displacing the one or more shaping elements with the at least one air-formed three-dimensional body of cellulose fibres away from the fibre outlet by movement of the support structure;
dry-forming the cellulose product into a three-dimensional compressed fibre structure in a pressing operation by pressing and heating one or more three-dimensional bodies of cellulose fibres in the forming mould with a forming pressure in the range of 1-600 MPa, and with a forming temperature in the range of 60-300° C.

2. The method according to claim 1,
wherein the three-dimensional surface is an outer surface of the one or more shaping elements, wherein the one or more shaping elements further comprise an inner surface opposite the outer surface, wherein the one or more shaping elements comprise a plurality of suction openings connecting the outer surface and the inner surface, wherein the method further comprises the steps:
arranging the loose and separated cellulose fibres onto the three-dimensional surface of the one or more shaping elements by means of the flow of air for air-forming the three-dimensional body of cellulose fibres, and applying a negative pressure via the suction openings for distributing the cellulose fibres onto the three-dimensional surface.

3. The method according to claim 1,
wherein the one or more shaping elements are arranged as three-dimensional net structures or as a solid perforated structures.

4. The method according to claim 1,
wherein the movable support structure is configured as a rotating support structure, wherein the method further comprises the steps: displacing the one or more shaping elements to the fibre outlet by rotational movement of the support structure, and displacing the one or more shaping elements with the at least one air-formed three-dimensional body of cellulose fibres away from the fibre outlet by rotational movement of the support structure.

5. The method according to claim 1,
wherein the movable support structure is configured as an endless circulating support structure, wherein the method further comprises the steps: displacing the one or more shaping elements to the fibre outlet by circulating movement of the support structure, and displacing the one or more shaping elements with the at least one air-formed three-dimensional body of cellulose fibres away from the fibre outlet by circulating movement of the support structure.

6. The method according to claim 1,
wherein the product forming unit further comprises a feeding unit, wherein the forming mould comprises one or more first mould parts and corresponding one or more second mould parts, wherein the method further comprises the steps:
feeding one or more air-formed three-dimensional bodies of cellulose fibres from the one or more shaping elements to the forming mould by means of the feeding unit, and arranging the one or more three-dimensional bodies of cellulose fibres into a position between the one or more first mould parts and corresponding one or more second mould parts; and
applying the forming pressure by pressing the one or more three-dimensional bodies of cellulose fibres between the one or more first mould parts and corresponding one or more second mould parts, and applying the forming temperature onto the one or more three-dimensional bodies of cellulose fibres in the forming mould.

7. The method according to claim 6,
wherein the feeding unit comprises the one or more first mould parts.

8. The method according to claim 1,
wherein the forming mould comprises one or more first mould parts and corresponding one or more seconds mould parts, wherein the one or more shaping elements are configured as the one or more first mould parts, wherein the method further comprises the steps:
applying the forming pressure by pressing the one or more three-dimensional bodies of cellulose fibres between the one or more first mould parts and the corresponding one or more second mould parts, and applying the forming temperature onto the one or more three-dimensional bodies of cellulose fibres in the forming mould.

9. The method according to claim 1, further comprising:
compacting the at least one three-dimensional body of cellulose fibres before dry-forming the cellulose product in the forming mould.

10. A product forming unit configured for dry-forming a three-dimensional cellulose product from cellulose fibres, wherein the product forming unit comprises a fibre transporting unit, a shaping unit, and a forming mould,
wherein the shaping unit comprises one or more shaping elements having a three-dimensional surface, wherein the one or more shaping elements are arranged on a movable support structure,
wherein the transporting unit is configured for feeding loose and separated cellulose fibres by means of a flow of air to a fibre outlet of the fibre transporting unit, and feeding the cellulose fibres from the fibre outlet to the shaping unit by means of the flow of air as carrying medium for the cellulose fibres,
wherein the support structure is configured for displacing the one or more shaping elements to the fibre outlet for arranging the loose and separated cellulose fibres onto the three-dimensional surfaces of the one or more shaping elements by means of the flow of air for air-forming at least one three-dimensional body of cellulose fibres having a shape corresponding to or similar to the forming mould, and displacing the one or more shaping elements with the at least one air-formed three-dimensional body of cellulose fibres away from the fibre outlet by movement of the support structure;
wherein the three-dimensional surfaces of the one or more shaping elements have a shape corresponding to a shape of a three-dimensional pressing surface of the forming mould;
wherein the forming mould is configured for dry-forming the cellulose product into a three-dimensional compressed fibre structure in a pressing operation by pressing and heating one or more three-dimensional bodies of cellulose fibres in the forming mould with a forming pressure in the range of 1-600 MPa, and with a forming temperature in the range of 60-300° C.

11. The product forming unit according to claim 10,
wherein the three-dimensional surface is an outer surface of the one or more shaping elements, wherein the one or more shaping element further comprise an inner surface opposite the outer surface, wherein the one or more shaping elements comprise a plurality of suction openings connecting the outer surface and the inner surface, wherein the three-dimensional surface is configured for receiving loose and separated cellulose fibres by means of the flow of air for air-forming the three-dimensional body of cellulose fibres upon application of a negative pressure via the suction openings for distributing the cellulose fibres onto the three-dimensional surface.

12. The product forming unit according to claim 10,
wherein the one or more shaping elements are arranged as a three-dimensional net structures or as solid perforated structures.

13. The product forming unit according to claim 10,
wherein the movable support structure is arranged as a rotating support structure configured for displacing the one or more shaping elements to the fibre outlet by rotational movement of the support structure, and configured for displacing the one or more shaping elements with the at least one air-formed three-dimensional body of cellulose fibres away from the fibre outlet by rotational movement of the support structure.

14. The product forming unit according to claim 10,
wherein the movable support structure is arranged as an endless circulating support structure configured for displacing the one or more shaping elements to the fibre outlet by circulating movement of the support structure, and configured for displacing the one or more shaping elements with the at least one air-formed three-dimensional body of cellulose fibres away from the fibre outlet by circulating movement of the support structure.

15. The product forming unit according to claim 10,
wherein the product forming unit further comprises a feeding unit, wherein the forming mould comprises one or more first mould parts and corresponding one or more second mould parts,
wherein the feeding unit is configured for feeding one or more air-formed three-dimensional bodies of cellulose fibres from the one or more shaping elements to the forming mould for arranging the one or more three-dimensional bodies of cellulose fibres into a position between the one or more first mould parts and corresponding one or more second mould parts,
wherein the forming mould is configured for applying the forming pressure by pressing the one or more three-dimensional bodies of cellulose fibres between the one or more first mould parts and corresponding one or more second mould parts, and applying the forming temperature onto the one or more three-dimensional bodies of cellulose fibres.

16. The product forming unit according to claim 15,
wherein the feeding unit comprises the one or more first mould parts.

17. The product forming unit according to claim 10,
wherein the forming mould comprises one or more first mould parts and corresponding one or more seconds mould parts, wherein the one or more shaping elements are configured as the one or more first mould parts,
wherein the forming mould is configured for applying the forming pressure by pressing the one or more three-dimensional bodies of cellulose fibres between the one or more first mould parts and the corresponding one or more second mould parts, and applying the forming temperature onto the one or more three-dimensional bodies of cellulose fibres in the forming mould.

18. A three-dimensional cellulose product comprising air-formed and compressed cellulose fibres, wherein the cellulose product comprises at least two air-formed three-dimensional bodies of cellulose fibres that are arranged in connection to each other in a slightly overlapping relationship in the forming mould, where less compacted overlapping sections of the three-dimensional bodies of cellulose fibres are attached to each other in the pressing operation.
